(19) United States
(12) Patent Application Publication
(10) Pub. No.: US 2018/0287869 A1
(43) Pub. Date: Oct. 4, 2018

(54) TECHNOLOGIES FOR ALTERING MODEM CONFIGURATIONS

(71) Applicant: Intel Corporation, Santa Clara, CA (US)

(72) Inventors: Tamir Damian Munafo, Har-Hotzbim (IL); Rajesh Poornachandran, Portland, OR (US); Rita H. Wouhaybi, Portland, OR (US); Ansuya Negi, Hillsboro, OR (US)

(21) Appl. No.: 15/473,370

(22) Filed: Mar. 29, 2017

(51) Int. Cl. H04L 12/24; H04L 29/08; H04L 12/26; H04W 12/08; H04W 12/06

(52) U.S. Cl. CPC H04L 41/0816; H04L 41/0843; H04L 41/0886; H04W 12/06; H04L 43/0811; H04W 12/08; H04L 67/12

(57) ABSTRACT

Methods, systems, and storage media are described for configuring a reconfigurable modem circuitry to communicate in accordance with various wireless communications protocols. A modem manager may be implemented in a secure execution environment of a computing platform. The modem manager may detect a trigger to reconfigure the modem circuitry, select a modem profile in response to the trigger, and reconfigure the modem circuitry in accordance with the selected modem profile. The modem circuitry, on reconfiguration, may communicate over a corresponding wireless network or in a corresponding network of the selected modem profile. Other embodiments may be described and/or claimed.

### FIELD

The present disclosure relates to the technical field of wireless communications, and in particular, to apparatuses, methods and storage media for altering or updating modem configurations.

### BACKGROUND

The Internet of Things (“IoT”) is a network of objects or “things”, each of which is embedded with hardware and/or software that enable connectivity to the network. An object, device, sensor, or “thing” (also referred to as an “IoT device”) that is connected to a network typically provides information to a manufacturer, operator, and/or other connected devices in order to track usage of the object and/or obtain services. IoT devices are deployed in homes, offices, manufacturing facilities, the natural environment, and inside biotic organisms. To provide various services, service providers may allow customers/users to implement their own network of IoT devices. Service providers may provide control and analytics for the IoT devices in an IoT network based on sensed information provided to the service provider by the IoT devices. Therefore, service providers heavily rely on the communication capabilities of IoT devices to deliver manageability, monitoring, and analytics services.

However, the communications circuitry implemented by most computing devices provide fixed functionality and are focused on providing communications using a specific communications protocol. In order to communicate using multiple protocols, an IoT device may require separate hardware components. For example, an IoT device may require a WiFi module to communicate using WiFi protocols and a Bluetooth module to communicate using the Bluetooth protocol. These components may take up space inside an already crowded IoT/mobile device platform. Furthermore, many IoT networks rely on the use of gateway devices (GWs) or access points (APs) to connect to service provider systems. GWs/APs may introduce a single point of failure, wherein IoT devices connected to a failing GW/AP may lose the analytics/intelligence capabilities resulting in poor user experience.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an arrangement showing interconnections that may be present between a network and Internet of Things (IoT) networks, in accordance with various embodiments;

FIG. 2 illustrates an example domain topology, in accordance with various embodiments;

FIG. 3 illustrates an example cloud computing network or cloud in communication with a number of IoT devices, in accordance with various embodiments;

FIG. 4 illustrates an arrangement of a cloud computing network or cloud in communication with a mesh network of IoT devices or IoT fog, in accordance with various embodiments;

FIG. 5 illustrates an arrangement in which various embodiments described in the present disclosure may be implemented;

FIG. 6 illustrates a first example implementation of a computing platform, in accordance with various embodiments;

FIG. 7 illustrates a second example implementation of a computing platform, in accordance with various embodiments;

FIG. 8 illustrates an example process for configuring a modem manager, in accordance with various embodiments; and

FIG. 9 illustrates an example process for operating a modem manager, in accordance with various embodiments.

### DETAILED DESCRIPTION

Embodiments discussed herein are directed towards configurable modems, which may be used in Internet of Things (IoT) devices. Communication modules in most IoT devices are fixed function devices, which communicate using a specific communications protocol (e.g., a WiFi, Bluetooth, etc.). In most cases, an IoT device may include one communication module to communicate using a single communication protocol (e.g., a WiFi module to communicate using WiFi signaling, a Bluetooth module to communicate using Bluetooth or BLE signaling, etc.). These IoT devices may connect to a backend service (e.g., application server(s), cloud service, etc.) via gateways devices (e.g., routers, hubs, etc.). In many cases, the gateway devices may be configured to communicate with the IoT devices using a single communication protocol. Such gateway devices may provide a single point of failure, which may prevent IoT devices from communicating with the backend service. In various embodiments, a computing platform, such as an IoT device, may include configurable modem circuitry that can be configured to communicate using different wireless communications protocols. In embodiments, the computing platform may detect a trigger, such as a gateway failure and the like, and reconfigure the modem circuitry in order to re-establish a connection with the backend service using a different communications pathway and/or different communications protocol.

Additionally, in various embodiments, the backend service may provide a user interface that allows an owner/operator of the computing platform to configure the platform to establish connections using a desired network or networks, and/or set network connection policies. In other embodiments, one or more artificial intelligence algorithms (also referred to as a “selection agent,” “intelligent agent,” etc.) may be implemented by the computing platform to reconfigure the modem circuitry based on current or predicted network conditions and/or based on one or more policies.

In the following detailed description, reference is made to the accompanying drawings that form a part hereof wherein like numerals designate like parts throughout, and in which is shown by way of illustrated embodiments that may be practiced. It is to be understood that other embodiments may be utilized and structural and/or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions and/or operations in turn, in a manner that is most helpful in understanding the claimed subject matter. However, the order of description should not be construed to imply that the various operations are necessarily order dependent. In particular, these operations may not be performed in the order of presentation. Operations described may be performed in a different order than the described embodiments. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). For the purposes of the present disclosure, the phrase “at least one of A and B” means (A), (B), or (A and B).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

Also, it is noted that embodiments may be described as a process depicted as a flowchart, a flow diagram, a dataflow diagram, a structure diagram, or a block diagram. Although a flowchart may describe the operations as a sequential process, many of the operations may be performed in parallel, concurrently, or simultaneously. In addition, the order of the operations may be re-arranged. A process may be terminated when its operations are completed, but may also have additional steps not included in the figure(s). A process may correspond to a method, a function, a procedure, a subroutine, a subprogram, and the like. When a process corresponds to a function, its termination may correspond to a return of the function to the calling function and/or the main function. Furthermore, a process may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium. A code segment may represent a procedure, a function, a subprogram, a program, a routine, a subroutine, a module, program code, a software package, a class, or any combination of instructions, data structures, program statements, and the like.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may implement, or functions associated with the circuitry may be implemented by, one or more software or firmware modules.

As used herein, the term “module” may include logic (including operating systems or application instructions, data, etc.) at least partially operable in circuitry. The circuitry may implement the module to cause the module to perform operations described herein.

As used herein, the term “memory” may represent one or more hardware devices for storing data, including random access memory (RAM), magnetic RAM, core memory, read only memory (ROM), magnetic disk storage mediums, optical storage mediums, flash memory devices and/or other machine readable mediums for storing data. The term “computer-readable medium” may include, but is not limited to, memory, portable or fixed storage devices, optical storage devices, wireless channels, and various other mediums capable of storing, containing or carrying instruction(s) and/or data.

As used herein, the term “computing platform” may be considered synonymous to, and may hereafter be occasionally referred to, as a computer device, computing device, client device or client, mobile, mobile unit, mobile terminal, mobile station, mobile user, mobile equipment, user equipment (UE), user terminal, machine-type communication (MTC) device, machine-to-machine (M2M) device, M2M equipment (M2ME), Internet of Things (IoT) device, subscriber, user, receiver, etc., and may describe any physical hardware device capable of sequentially and automatically carrying out a sequence of arithmetic or logical operations, equipped to record/store data on a machine readable medium, and transmit and receive data from one or more other devices in a communications network. Furthermore, the term “computing platform” may include any type of electronic devices, such as a cellular phone or smartphone, a tablet personal computer, a wearable computing device, an autonomous sensor, personal digital assistants (PDAs), a laptop computer, a desktop personal computer, a video game console, a digital media player, an in-vehicle infotainment (IVI) and/or an in-car entertainment (ICE) device, a vehicle-to-vehicle (V2V) communication system, a vehicle-to-everything (V2X) communication system, a handheld messaging device, a personal data assistant, an electronic book reader, an augmented reality device, and/or any other like electronic device.

As used herein, the term “network element” may be considered synonymous to and/or referred to as a networked computer, networking hardware, network equipment, access point, router, switch, hub, bridge, gateway, base station, core network element, server, and/or other like device. The term “network element” may describe a physical hardware device of a wired or wireless communication network that is configured to host a client device and the like. The term “network element” may describe equipment that provides radio baseband functions for data and/or voice connectivity between a network element and one or more users. As used herein, a “network element” may comprise one or more devices that provide multiple radio frequency networks, such as a WiFi wireless router that may provide a WLAN in accordance with an Institute of Electrical and Electronics Engineers (IEEE) 802.11 protocol; one or more base stations that may provide a cellular communications network such as Long Term Evolution (LTE), Universal Mobile Telecommunications System (UMTS), Global System for Mobile Communications (GSM), Enhanced Data GSM Environment (EDGE), Worldwide Interoperability for Microwave Access (WiMAX), an IEEE 802.16 network, and the like; a device that may provide personal area networks (PANs) or other like networks based on one or more IEEE 802.15.4 based protocols (e.g., a 6LoWPAN, ZigBee, Thread, etc.); Bluetooth or Bluetooth Low Energy (BLE) protocols; ANT protocol; LTE device-to-device (D2D) or Proximity Services (ProSe) protocols; Z-Wave protocol; SigFox protocol; Platanus protocol; and/or the Universal Plug and Play (UPnP) protocol.

As used herein, the term “link” as used herein may refer to any transmission medium, either tangible or intangible, which is used to communicate data or a data stream. Additionally, the term “link” may be synonymous with and/or equivalent to “communications channel,” “data communications channel,” “transmission channel,” “data transmission channel,” “access channel,” “data access channel,” “channel,” “data link,” “radio link,” “carrier,” “radiofrequency carrier,” and/or any other like term denoting a pathway or medium through which data is communicated.

As used herein, the term “network operator” may be considered synonymous to and/or referred to as a mobile network operator (MNO), cellular network operator, wireless service provider, wireless carrier, mobile network carrier, virtual MNO, and/or the like. The term “network operator” may describe any provider of services related to a communications network including wired and wireless communications networks. Furthermore, the term “network operator” may describe an entity that owns or controls elements necessary to provide communications network-related services, including radio spectrum allocation including one or more radio spectrum licenses from a regulatory agency, wireless network infrastructure and/or back haul infrastructure, billing and subscription-related services, provisioning computer systems, and/or other like services.

The internet of things (IoT) is a concept in which a large number of computing devices are interconnected to each other and to the Internet to provide functionality and data acquisition at very low levels. As used herein, an IoT device may include a semiautonomous device performing a function, such as sensing or control, among others, in communication with other IoT devices and a wider network, such as the Internet. Often, IoT devices are limited in memory, size, or functionality, allowing larger numbers to be deployed for a similar cost to smaller numbers of larger devices. However, an IoT device may be a smart phone, laptop, tablet, or PC, or other larger device. Further, an IoT device may be a virtual device, such as an application on a smart phone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

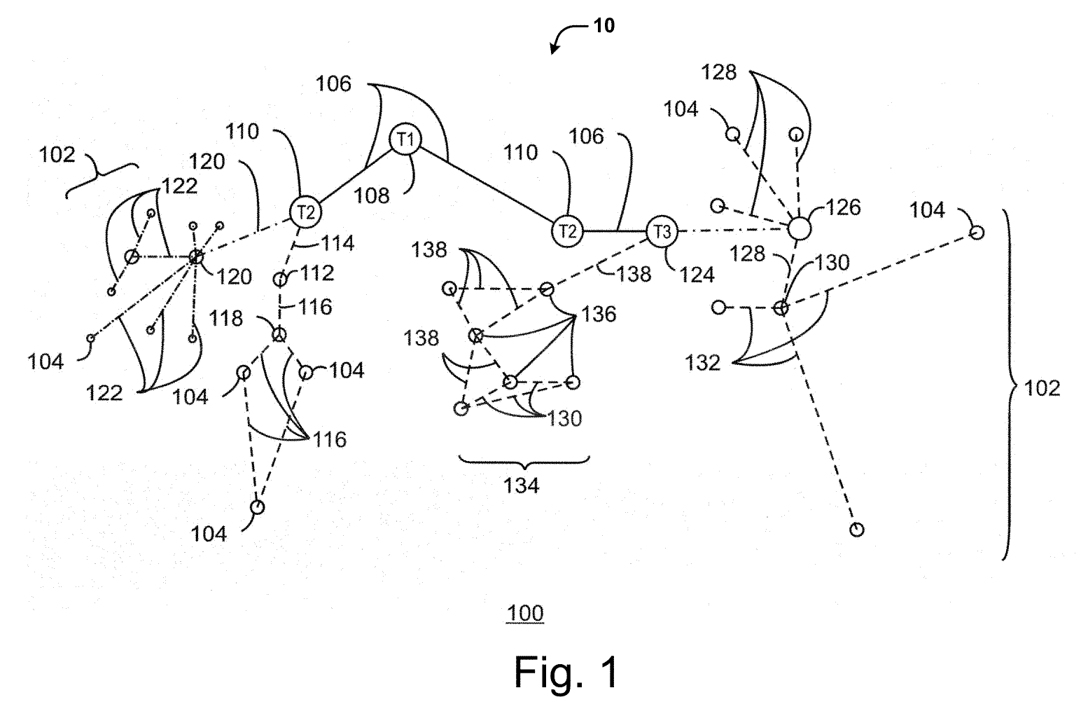

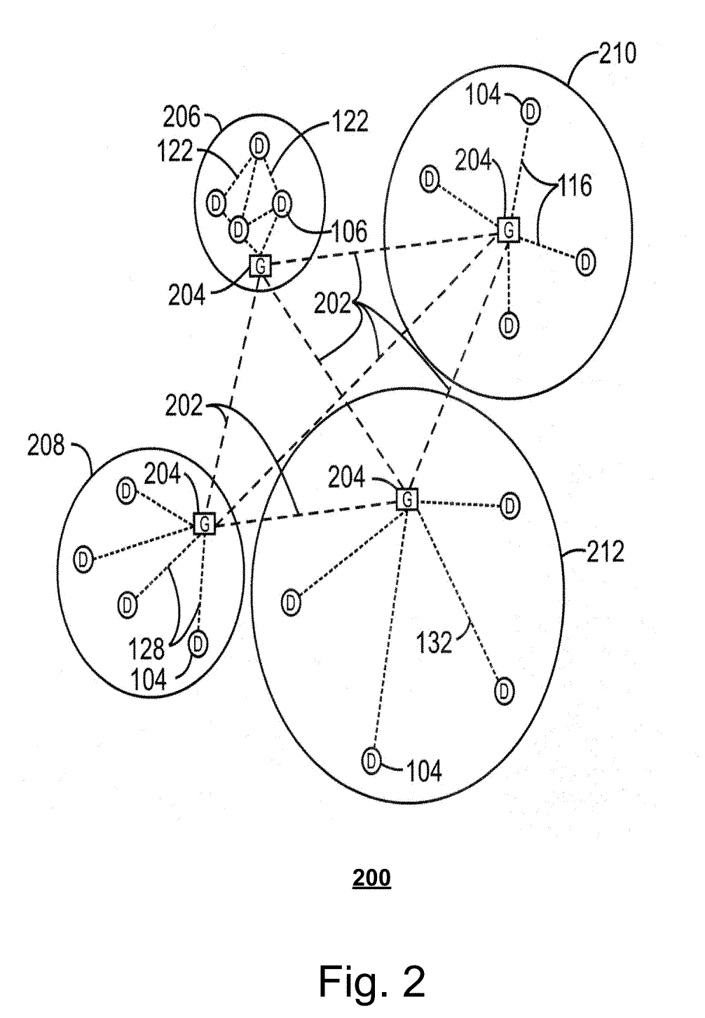

The future growth of the Internet may include very large numbers of IoT devices. Accordingly, as described herein, a number of innovations for the future Internet address the need for all these layers to grow unhindered, to discover and make accessible connected resources, and to support the ability to hide and compartmentalize connected resources. Any number of network protocols and communications standards may be used, wherein each protocol and standard is designed to address specific objectives. Further, the protocols are part of the fabric supporting human accessible services that operate regardless of location, time or space. The innovations include service delivery and associated infrastructure, such as hardware and software. The services may be provided in accordance with the Quality of Service (QoS) terms specified in service level and service delivery agreements. The use of IoT devices and networks present a number of new challenges in a heterogeneous network of connectivity comprising a combination of wired and wireless technologies as depicted in FIGS. 1 and 2.

FIG. 1 illustrates an arrangement 10 showing interconnections that may be present between the Internet 100 and IoT networks, in accordance with various embodiments. The interconnections may couple smaller networks 102, down to the individual IoT device 104, to the fiber backbone 106 of the Internet 100. To simplify the drawing, not every device 104, or other object, is labeled.

In FIG. 1, top-level providers, which may be termed tier 1 providers 108, are coupled by the fiber backbone of the Internet to other providers, such as secondary or tier 2 providers 110. In one example, a tier 2 provider 110 may couple to a tower 112 of an LTE cellular network, for example, by further fiber links, by microwave communications 114, or by other communications technologies. The tower 112 may couple to a mesh network including IoT devices 104 through an LTE communication link 116, for example, through a central node 118. The communications between the individual IoT devices 104 may also be based on LTE communication links 116. In another example, a high-speed uplink 120 may couple a tier 2 provider 110 to a gateway (GW) 120. A number of IoT devices 104 may communicate with the GW 120, and with each other through the GW 120, for example, over BLE links 122.

The fiber backbone 106 may couple lower levels of service providers to the Internet, such as tier 3 providers 124. A tier 3 provider 124 may be considered a general Internet service provider (ISP), for example, purchasing access to the fiber backbone 110 from a tier 2 provider 110 and providing access to a corporate GW 126 and other customers. From the corporate GW 126, a wireless local area network (WLAN) can be used to communicate with IoT devices 104 through Wi-Fi® links 128. A Wi-Fi link 128 may also be used to couple to a low power wide area (LPWA) GW 130, which can communicate with IoT devices 104 over LPWA links 132, for example, compatible with the LoRaWan specification promulgated by the LoRa alliance.

The tier 3 provider 124 may also provide access to a mesh network 134 through a coordinator device 136 that communicates with the tier 3 provider 124 using any number of communications links, such as an LTE cellular link, an LPWA link, or a link 138 based on the IEEE 802.15.4 standard, such as Zigbee®. Other coordinator devices 136 may provide a chain of links that forms cluster tree of linked devices.

IoT devices 104 may be any object, device, sensor, or “thing” that is embedded with hardware and/or software components that enable the object, device, sensor, or “thing” capable of capturing and/or recording data associated with an event, and capable of communicating such data with one or more other devices over a network with little or no user intervention. For instance, in various embodiments, IoT devices 104 may be abiotic devices such as autonomous sensors, gauges, meters, image capture devices, microphones, MTC devices, M2M devices, light emitting devices, audio emitting devices, audio and/or video playback devices, electro-mechanical devices (e.g., switch, actuator, etc.), and the like. In some embodiments, IoT devices 104 may be biotic devices such as monitoring implants, biosensors, biochips, and the like. In other embodiments, an IoT device 104 may be a computer device that is embedded in a computer system and coupled with communications circuitry of the computer system. In such embodiments, the IoT device 104 may be a system on chip (SoC), a universal integrated circuitry card (UICC), an embedded UICC (eUICC), and the like, and the computer system may be a mobile station (e.g., a smartphone) or user equipment, laptop PC, wearable device (e.g., a smart watch, fitness tracker, etc.), “smart” appliance (e.g., a television, refrigerator, a security system, etc.), and the like.

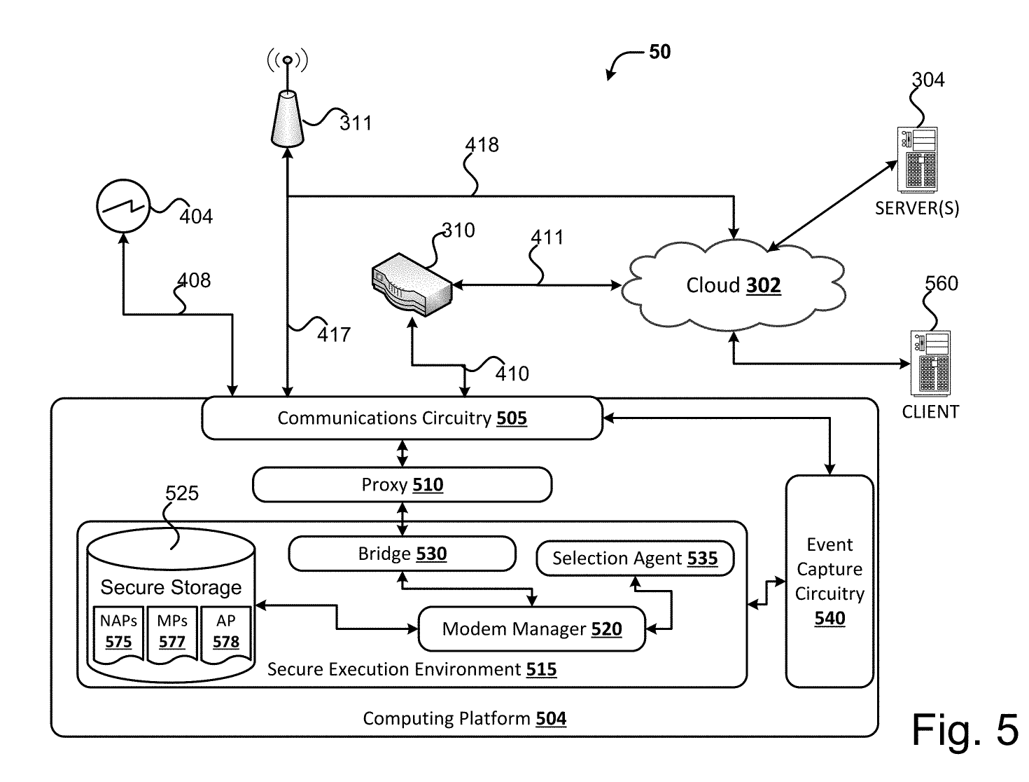

Each of the IoT devices 104 may include one or more memory devices and one or more processors to capture and store/record data. Each of the IoT devices 104 may include appropriate communications circuitry (e.g., transceiver(s), modem, antenna elements, etc.) to communicate (e.g., transmit and receive) captured and stored/recorded data. Further, each IoT device 104 may include other transceivers for communications using additional protocols and frequencies. This is discussed further with respect to FIGS. 5-9. According to various embodiments, the IoT devices 104 may be equipped with information (e.g., referred to as “modem profiles” herein) to configure configurable communications circuitry to perform communications in a corresponding communications. This may allow the IoT devices 104 to communicate using multiple wireless communications protocols without requiring an IoT device 104 to include separate hardware communications modules for each wireless communications protocol. The wireless communications protocols may be any suitable set of standardized rules or instructions implemented by the IoT devices 104 to communicate with other devices, including instructions for packetizing/depacketizing data, instructions for modulating/demodulating signals, instructions for implementation of protocols stacks, and the like. For example, IoT devices 104 may include communications circuitry that is configurable to communicate in accordance with one or more person-to-person (P2P) or personal area network (PAN) protocols (e.g., IEEE 802.15.4 based protocols including ZigBee, IPv6 over Low power Wireless Personal Area Networks (6LoWPAN), WirelessHART, MiWi, Thread, etc.; WiFi-direct; Bluetooth/BLE protocols; ANT protocols; Z-Wave; LTE D2D or ProSe; UPnP; and the like); configurable to communicate using one or more LAN and/or WLAN protocols (e.g., Wi-Fi-based protocols or IEEE 802.11 protocols, such as IEEE 802.16 protocols); one or more cellular communications protocols (e.g., LTE/LTE-A, UMTS, GSM, EDGE, Wi-MAX, etc.); and the like.

In embodiments, one or more of tower 112, GW 120, 126, and 130, coordinator device 136, and so forth, may also be incorporated with the modem technology described herein, in particular, with references to FIGS. 5-9.

The technologies and networks may enable the exponential growth of devices and networks. As the technologies grow, the network may be developed for self-management, functional evolution, and collaboration, without needing direct human intervention. Thus, the technologies will enable networks to function without centralized controlled systems. The technologies described herein may automate the network management and operation functions beyond current capabilities.

FIG. 2 illustrates an example domain topology 200 that may be used for a number of IoT networks coupled through backbone links 202 to GWs 204, in accordance with various embodiments. Like numbered items are as described with respect to FIG. 1. Further, to simplify the drawing, not every device 104, or communications link 116, 122, 128, or 132 is labeled. The backbone links 202 may include any number of wired or wireless technologies, and may be part of a local area network (LAN), a wide area network (WAN), or the Internet. Similar to FIG. 1, in embodiments, one or more of IoT devices 124, GW 204, and so forth, may be incorporated with the modem technology described herein, in particular, with references to FIGS. 5-9.

The network topology 200 may include any number of types of IoT networks, such as a mesh network 206 using BLE links 122. Other IoT networks that may be present include a WLAN network 208, a cellular network 210, and an LPWA network 212. Each of these IoT networks may provide opportunities for new developments, as described herein. For example, communications between IoT devices 104, such as over the backbone links 202, may be protected by a decentralized system for authentication, authorization, and accounting (AAA). In a decentralized AAA system, distributed payment, credit, audit, authorization, and authentication systems may be implemented across interconnected heterogeneous infrastructure. This allows systems and networks to move towards autonomous operations.

In these types of autonomous operations, machines may contract for human resources and negotiate partnerships with other machine networks. This may allow the achievement of mutual objectives and balanced service delivery against outlined, planned service level agreements as well as achieve solutions that provide metering, measurements and traceability and trackability. The creation of new supply chain structures and methods may enable a multitude of services to be created, mined for value, and collapsed without any human involvement.

The IoT networks may be further enhanced by the integration of sensing technologies, such as sound, light, electronic traffic, facial and pattern recognition, smell, vibration, into the autonomous organizations. The integration of sensory systems may allow systematic and autonomous communication and coordination of service delivery against contractual service objectives, orchestration and quality of service (QoS) based swarming and fusion of resources.

The mesh network 206 may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource based trust and service indices may be inserted to improve the data integrity, quality, assurance and deliver a metric of data confidence.

The WLAN network 208 may use systems that perform standards conversion to provide multi-standard connectivity, enabling IoT devices 104 using different protocols to communicate. Further systems may provide seamless interconnectivity across a multi-standard infrastructure comprising visible Internet resources and hidden Internet resources.

Communications in the cellular network 210 may be enhanced by systems that offload data, extend communications to more remote devices, or both. The LPWA network 212 may include systems that perform non-Internet protocol (IP) to IP interconnections, addressing, and routing.

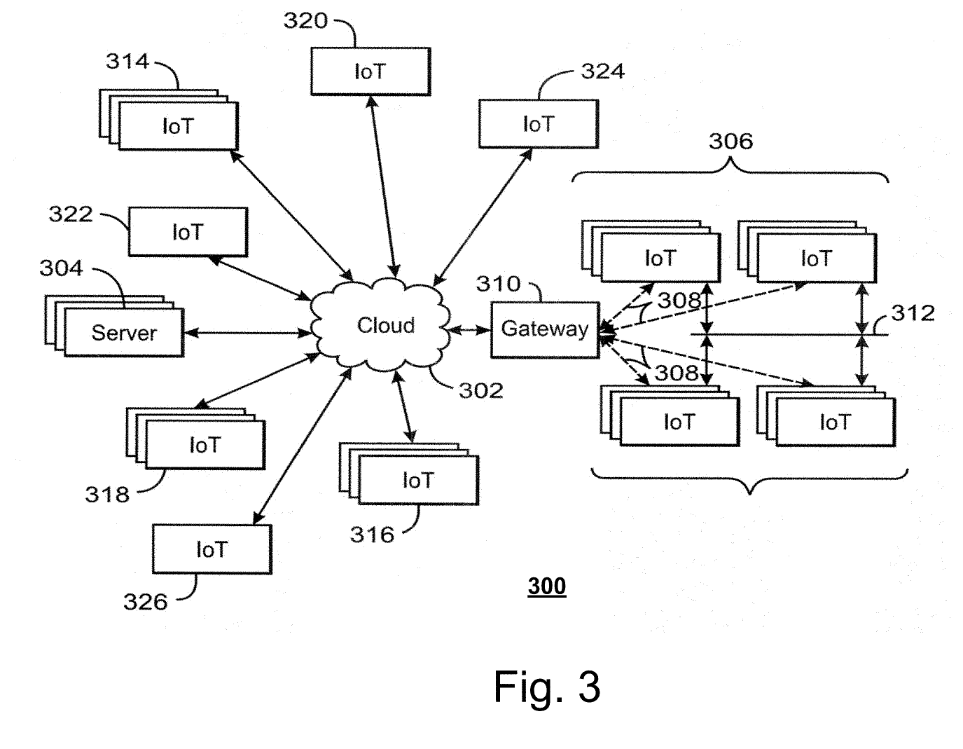

FIG. 3 illustrates an example cloud computing network, or cloud 302, in communication with a number of Internet of Things (IoT) devices, in accordance with various embodiments. The cloud 302 may represent the Internet, one or more cellular networks, a local area network (LAN) or a wide area network (WAN) including proprietary and/or enterprise networks for a company or organization, or combinations thereof. Components used for such communications system can depend at least in part upon the type of network and/or environment selected. Protocols and components for communicating via such networks are well known and will not be discussed herein in detail. However, it should be appreciated that cloud 302 may be associated with network operator who owns or controls equipment and other elements necessary to provide network-related services, such as one or more base stations or access points, and one or more servers for routing digital data or telephone calls (for example, a core network or backbone network).

The IoT devices in FIG. 3 may be the same or similar to the IoT devices 104 discussed with regard to FIGS. 1-2. The IoT devices may include any number of different types of devices, grouped in various combinations, such as IoT group 306 that may include IoT devices that provide one or more services for a particular user, customer, organizations, etc. A service provider may deploy the IoT devices in the IoT group 306 to a particular area (e.g., a geolocation, building, etc.) in order to provide the one or more services. In one example, the IoT group 306 may be a traffic control group where the IoT devices in the IoT group 306 may include stoplights, traffic flow monitors, cameras, weather sensors, and the like, to provide traffic control and traffic analytics services for a particular municipality or other like entity. Similar to FIGS. 1-2, in embodiments, one or more of IoT devices 314-324, GW 310, and so forth, may be incorporated with the modem technology described herein, in particular, with references to FIGS. 5-9.

The IoT group 306, or other subgroups, may be in communication with the cloud 302 through wireless links 308, such as LPWA links, and the like. Further, a wired or wireless sub-network 312 may allow the IoT devices to communicate with each other, such as through a local area network, a wireless local area network, and the like. The IoT devices may use another device, such as a GW 310 to communicate with the cloud 302. Other groups of IoT devices may include remote weather stations 314, local information terminals 316, alarm systems 318, automated teller machines 320, alarm panels 322, or moving vehicles, such as emergency vehicles 324 or other vehicles 326, among many others. Each of these IoT devices may be in communication with other IoT devices, with servers 304, or both.

As can be seen from FIG. 3, a large number of IoT devices may be communicating through the cloud 302. This may allow different IoT devices to request or provide information to other devices autonomously. For example, the IoT group 306 may request a current weather forecast from a group of remote weather stations 314, which may provide the forecast without human intervention. Further, an emergency vehicle 324 may be alerted by an automated teller machine 320 that a burglary is in progress. As the emergency vehicle 324 proceeds towards the automated teller machine 320, it may access the traffic control group 306 to request clearance to the location, for example, by lights turning red to block cross traffic at an intersection in sufficient time for the emergency vehicle 324 to have unimpeded access to the intersection.

In another example, the IoT group 306 may be an industrial control group (also referred to as a “connected factory”, an “industry 4.0” group, and the like) where the IoT devices in the IoT group 306 may include machines or appliances with embedded IoT devices, radiofrequency identification (RFID) readers, cameras, client computer devices within a manufacturing plant, and the like, to provide production control, self-optimized or decentralized task management services, analytics services, etc. for a particular manufacturer or factory operator. In this example, the IoT group 306 may communicate with the servers 304 via GW 310 and cloud 302 to provide captured data, which may be used to provide performance monitoring and analytics to the manufacturer or factory operator. Additionally, the IoT devices in the IoT group 306 may communicate among each other, and/or with other IoT devices of other IoT groups, to make decisions on their own and to perform their tasks as autonomously as possible.

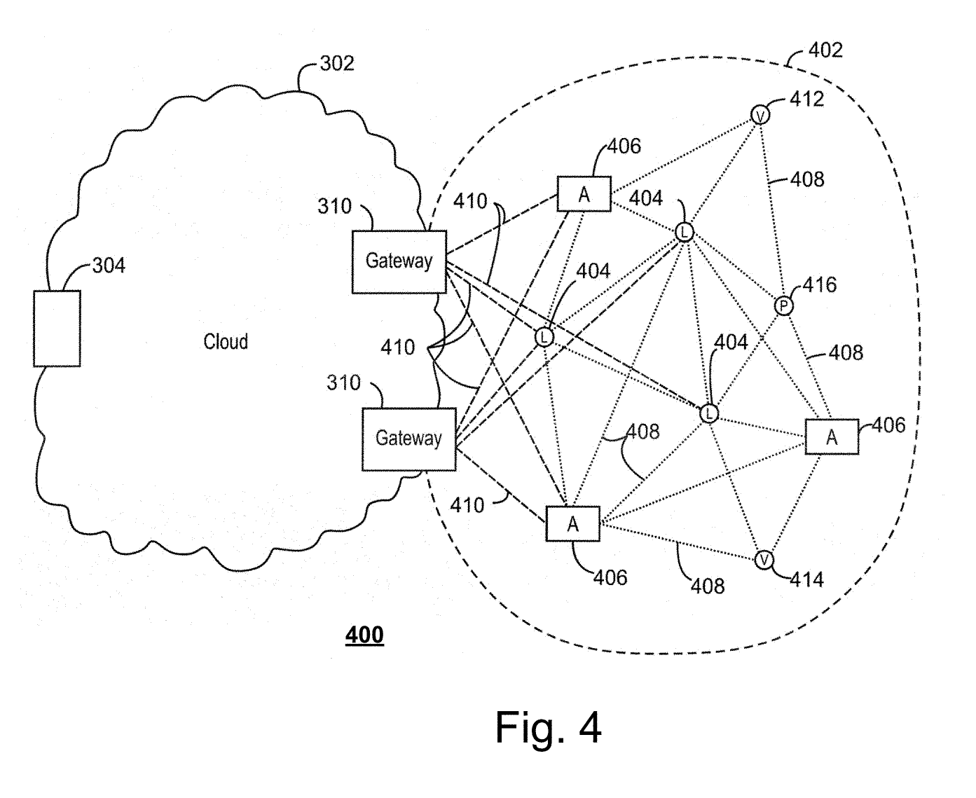

Clusters of IoT devices, such as the IoT groups depicted by FIG. 3, may be equipped to communicate with other IoT devices as well as with the cloud 302. This may allow the IoT devices to form an ad-hoc network between the devices, allowing them to function as a single device, which may be termed a fog device. This is discussed further with respect to FIG. 4.

FIG. 4 illustrates an arrangement 400 of a cloud computing network, or cloud 302, in communication with a mesh network of IoT devices, which may be termed a fog device 402, operating at the edge of the cloud 302, in accordance with various embodiments. Like numbered items are as described with respect to FIGS. 1-3. In this example, the fog device 402 is a group of IoT devices at an intersection. The fog device 402 may be established in accordance with specifications released by the OpenFog Consortium (OFC), the Open Connectivity Foundation™ (OCF), among others.

Data may be captured, stored/recorded, and communicated among the IoT devices 404. Analysis of the traffic flow and control schemes may be implemented by aggregators 406 that are in communication with the IoT devices 404 and each other through a mesh network. Data may be uploaded to the cloud 302, and commands received from the cloud 302, through GWs 310 that are in communication with the IoT devices 404 and the aggregators 406 through the mesh network. Similar to FIGS. 1-3, in embodiments, one or more of IoT devices 404, aggregators 406, and so forth, may be incorporated with the modem technology described herein, in particular, with references to FIGS. 5-9.

Any number of communications links may be used in the fog device 402. Shorter-range links 408, for example, compatible with IEEE 802.15.4 may provide local communications between IoT devices that are proximate to one another or other devices. Longer-range links 410, for example, compatible with LPWA standards, may provide communications between the IoT devices and the GWs 310. To simplify the diagram, not every communications link 408 or 410 is labeled with a reference number.

The fog device 402 may be considered to be a massively interconnected network wherein a number of IoT devices are in communications with each other, for example, by the communication links 408 and 410. The network may be established using the open interconnect consortium (OIC) standard specification 1.0 released by the Open Connectivity Foundation™ (OCF) on Dec. 23, 2015. This standard allows devices to discover each other and establish communications for interconnects. Other interconnection protocols may also be used, including, for example, the AllJoyn protocol from the AllSeen alliance, the optimized link state routing (OLSR) Protocol, or the better approach to mobile ad-hoc networking (B.A.T.M.A.N), among many others.

Communications from any IoT device may be passed along the most convenient path between any of the IoT devices to reach the GWs 310. In these networks, the number of interconnections may provide substantial redundancy, allowing communications to be maintained, even with the loss of a number of IoT devices.

Not all of the IoT devices may be permanent members of the fog device 402. In the example in the drawing 400, three transient IoT devices have joined the fog device 402, a first mobile device 412, a second mobile device 414, and a third mobile device 416. The fog device 402 may be presented to clients in the cloud 302, such as the server 304, as a single device located at the edge of the cloud 302. In this example, the control communications to specific resources in the fog device 402 may occur without identifying any specific IoT device 404 within the fog device 402. Accordingly, if any IoT device 404 fails, other IoT devices 404 may be able to discover and control a resource. For example, the IoT devices 404 may be wired so as to allow any one of the IoT devices 404 to control measurements, inputs, outputs, etc., for the other IoT devices 404. The aggregators 406 may also provide redundancy in the control of the IoT devices 404 and other functions of the fog device 402.

In some examples, the IoT devices may be configured using an imperative programming style, e.g., with each IoT device having a specific function and communication partners. However, the IoT devices forming the fog device 402 may be configured in a declarative programming style, allowing the IoT devices to reconfigure their operations and communications, such as to determine needed resources in response to conditions, queries, and device failures. This may be performed as transient IoT devices, such as the devices 412, 414, 416, join the fog device 402. As transient or mobile IoT devices enter or leave the fog 402, the fog device 402 may reconfigure itself to include those devices. This may be performed by forming a temporary group of the devices 412 and 414 and the third mobile device 416 to control or otherwise communicate with the IoT devices 404. If one or both of the devices 412, 414 are autonomous, the temporary group may provide instructions to the devices 412, 414. As the transient devices 412, 414, and 416, leave the vicinity of the fog device 402, it may reconfigure itself to eliminate those IoT devices from the network. The fog device 402 may also divide itself into functional units, such as the IoT devices 404 and other IoT devices proximate to a particular area or geographic feature, or other IoT devices that perform a particular function. This type of combination may enable the formation of larger IoT constructs using resources from the fog device 402.

As illustrated by the fog device 402, the organic evolution of IoT networks is central to maximizing the utility, availability and resiliency of IoT implementations. Further, the example indicates the usefulness of strategies for improving trust and therefore security. The local identification of devices may be important in implementations, as the decentralization of identity ensures a central authority cannot be exploited to allow impersonation of objects that may exist within the IoT networks. Further, local identification lowers communication overhead and latency.

FIG. 5 shows an arrangement 50 in accordance with various embodiments. Like numbered items are as described with respect to FIGS. 1-4. In FIG. 5, arrangement 50 may include cloud 302, IoT device 404, server(s) 304, client computer device 560 (also referred to as “client 560”), GW 310, and base station (BS) 311. Arrangement 50 may include many more devices, components, or other elements than shown by FIG. 5, and thus, the depiction of the arrangement 50 in FIG. 5 should be taken as being illustrative in nature, and not limited to the scope of the disclosure.

Computing platform 504 may be a physical hardware device capable of sequentially and automatically carrying out a sequence of arithmetic or logical operations, recording, storing, and/or transferring digital data via a wired or wireless connection with one or more network elements and/or one or more other devices. In embodiments, computing platform 504 may be an IoT device that is the same or similar to the IoT devices discussed previously (e.g., IoT devices 104, 304, 404). In other embodiments, computing platform 504 may be a computer device embedded within a computer system, or computing platform 504 may be some other type of computer device.

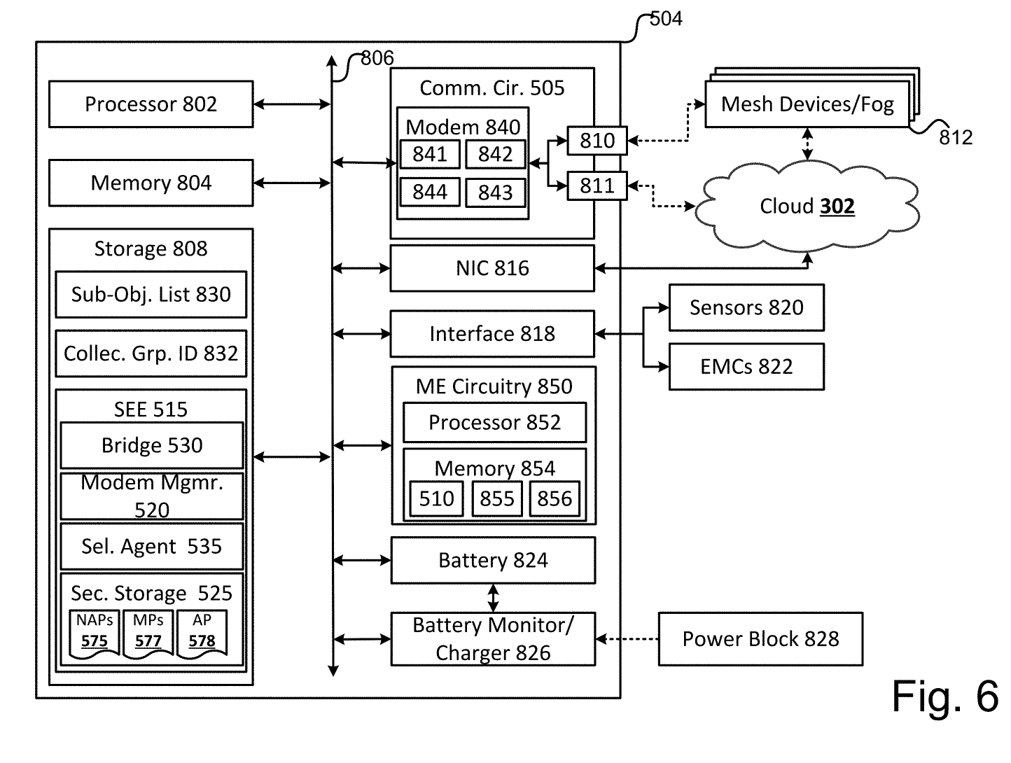

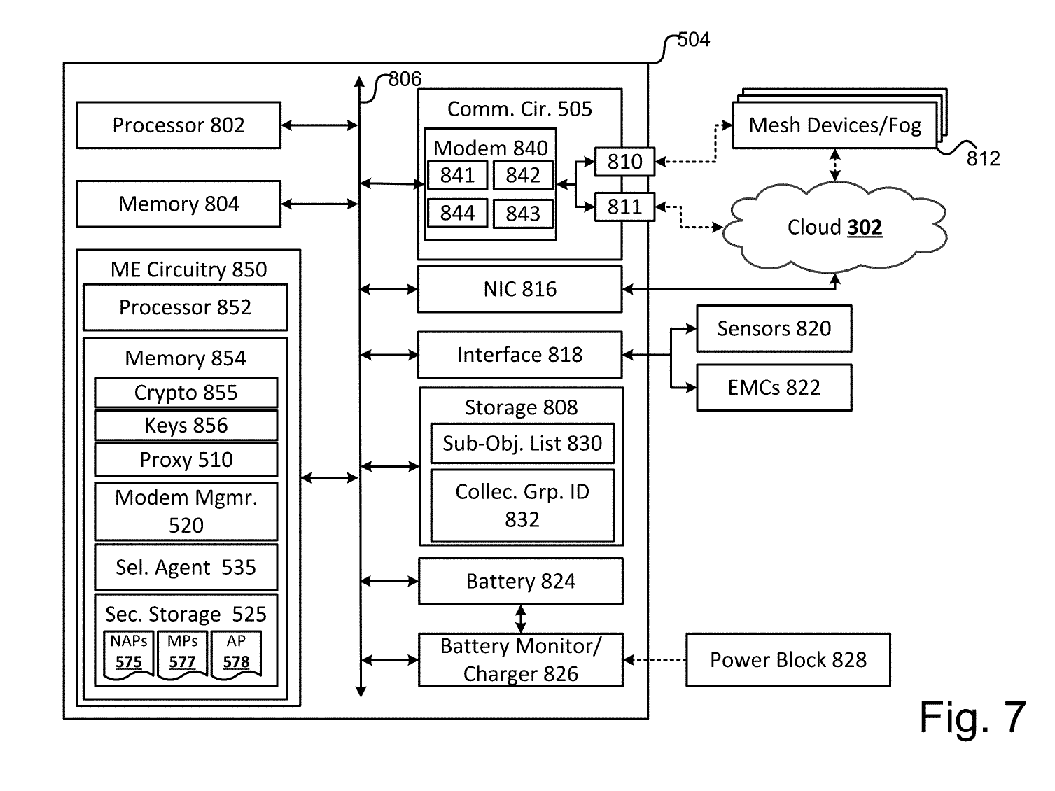

Computing platform 504 may include event capture circuitry 540 that is capable of capturing and/or recording data associated with an event with little or no user intervention. The event capture circuitry 540 may include one or more sensors, processors, and memory devices, which are discussed in more detail with regard to FIGS. 6-7. An event may be any occurrence of an action, such as a change in a meter/sensor/gauge reading, an electrical output, an electrical input, receipt of one or more messages from other devices, a biotic action (e.g., a heart rate, a glucose level), a state/position/orientation change, a change in a mode of operation of the computing platform 504, and the like. The service provider (e.g., an operator of the server(s) 304), a user of the client 560 or client 560 itself, computing platform 504, and/or an IoT device 404 may take an appropriate action based on a notification of the event. In various embodiments, an event may be detected, captured, and recorded/stored by the event capture circuitry 540 based on sensor inputs and/or outputs, timer values, user actions, etc.

Once event capture circuitry 540 captures and stores/records data associated with an event, the event capture circuitry 540 may notify the service provider and/or client 560 of the event by providing the captured data (or a message containing the captured data) to the communications circuitry 505. The communications circuitry 505 may include one or more hardware devices that allow the computing platform 504 to communicate with other devices. These components are discussed in more detail with regard to FIGS. 6-7. The communications circuitry 505 may package the captured data according to a communications protocol and send the packaged data to the GW 310 over long-range link 410. In some embodiments, data captured by the IoT device 404 may be provided to the computing platform 504 via short range link 408, and the computing platform 504 may use the communication circuitry 505 to relay that data to the server(s) 304 and/or client 560 via the GW 310. The process of capturing, recording, and transmitting data by the computing platform 504 may be referred to as “reporting.” The computing platform 504 may report data on a period or cyclical basis, or based on a configurable desired event or trigger that is identified by computing platform 504.

After the GW 310 obtains the data from the computing platform 504, the GW 310 may send the data to the cloud 302 over the backhaul link 411, and the packaged data may eventually be provided to the server(s) 304 and/or client 560. The GW 310 may be a network element that employs multi-radio frequency networks technology to provide communication services to computing platform 504 and/or IoT devices 404 in a given environment. In this regard, the GW 310 may act as a centralized hub and/or scheduler for the computing platform 504 and/or IoT devices 404. The GW 310 may also communicate data to/from the server(s) 304 via the cloud 302 on behalf of the computing platform 504 and/or IoT devices 404. In this way, GW 310 may act as a single point of contact between devices that are unable to directly connect to larger networks (e.g., cloud 302) and remote computer devices (e.g., server(s) 304 and client 560).

In embodiments, the GW 310 may be a standalone device that is specifically manufactured to provide IoT devices 104 connectivity to cloud 302, such as an IoT GW or an automation hub. In such embodiments, the GW 310 may be communicatively coupled with a wireless access point (WAP) or other like device that may provide network connectivity to the elements in arrangement 50 (not shown by FIG. 5). Further, in such embodiments, the GW 310 may be communicatively coupled with the WAP through a wired or wireless connection. In other embodiments, the GW 310 may be a WAP, a home server coupled with RF communications circuitry, a smallcell base station (e.g., a femtocell, picocell, home evolved nodeB (HeNB), and the like), a router, a switch, a hub, a radio beacon, and/or any other like network device.

The GW 310 may include one or more processors, communications circuitry (e.g., including a network interface, one or more transmitters/receivers connected to one or more antennas, and the like), and computer readable media. The one or more transmitters/receivers (or transceivers) may be configured to wirelessly transmit/receive RF signals to/from one or more IoT devices 404, computing platform 504, and/or client 560 within the environment, and the network interface may be configured to transmit/receive data to/from server(s) 304 via cloud 302 using a wired connection. The GW 310 may process and/or route data packets over the wired connection according to one or more communications protocols discussed herein.

In situations where the GW 310 becomes overloaded, becomes a bottleneck, or otherwise fails, the computing platform 504 may be capable detecting such a failure, and capable of configuring the communications circuitry 505 to directly or indirectly communicate with BS 311 over radiolink 417. As an example, the BS 311 may be a base station associated with a cellular network (e.g., an evolved NodeB (eNB) in an LTE network, a next generation nodeB (gNB) in a new radio access technology (NR) network, a WiMAX base station, etc.). In these scenarios, the computing platform 504 may report data in the same or similar manner as discussed previously, except that data may be sent to the BS 311 over link 417, and the BS 311 may provide the data to the cloud 302 over backhaul link 418.

According to various embodiments, the computing platform 504 may operate one or more applications in order to configure the communications circuitry 505 to communicate with the BS 311. These applications may include the proxy 510 and the modem manager 520 within the secure execution environment (SEE) 515, as well as the SEE 515 itself.

The proxy 510 may be one or more software modules that operate in conjunction with one or more hardware devices to secure communications between the modem manager 520 within the SEE 515 and the communications circuitry 505 outside of the SEE 515. The proxy 510 may be implemented in a physical hardware device that is separate from other components of the computing platform 504 (e.g., the embodiments shown and described with regard to FIG. 7), or may be implemented in application circuitry (e.g., the embodiment shown and described with regard to FIG. 6). In either embodiment, the proxy 510 may be a security application or application programming interface (API) allowing untrusted applications (not shown) and components of the computing platform 504 to interact with the modem manager 520 within the SEE 515. In some embodiments, the proxy 510 may be implemented as middleware or “software glue,” which is used to connect two or more separate applications or connect applications with underlying hardware components beyond those available from an operating system and/or drivers. The proxy 510 may be the only element that is outside of the SEE 515 that is capable of communicating with the modem manager 520 within the SEE 515. For example, the proxy 510 may communicate with the modem manager 520 and various untrusted applications or components in a same or similar manner as discussed in commonly assigned International Application No. PCT/US2016/037634, titled INTEGRATED UNIVERSAL INTEGRATED CIRCUIT CARD ON MOBILE COMPUTING ENVIRONMENTS, filed on Jun. 15, 2016, which is hereby incorporated by reference in its entirety and for all purposes.

SEE 515 (also referred to as a “trusted execution environment” or “TEE”) may be one or more hardware devices and/or one or more software modules that carry out secure operations and/or control the storage and use of personal and/or confidential data. In embodiments, the one or more hardware devices may be tamper resistant and the operations may be carried out independent of the processor(s) of the host/application platform. In embodiments where the SEE 515 is implemented as one or more software modules, the software modules may include “enclaves” (also referred to as “secure enclaves”), which may be isolated regions of code and/or data within the memory of the computing platform 504. In such embodiments, the enclave including the modem manager 520 may be referred to as a “modem manager enclave,” “modem enclave,” and the like. Only code executed within a secure enclave may access data within the same secure enclave, and the secure enclave may only be accessible using the secure application (e.g., proxy 510). The secure application may be implemented by an application processor or a tamper-resistant microcontroller. The secure enclaves may be defined using the Intel® Software Guard Extensions (SGX). Examples of such embodiments are shown by FIG. 6.

In other embodiments, SEE 515 may be implemented as a physical hardware device that is separate from other components of the computing platform 504. In such embodiments, SEE 515 may be a secure-embedded controller, such as a tamper-resistant microcontroller with embedded processors and memory devices. The tamper-resistant microcontroller may be referred to as a management engine (ME) or ME circuitry. In such embodiments, applications that are not within the SEE 515 may communicate with ME circuitry via secure application (e.g., proxy 510) that may also be implemented by the ME circuitry. The ME circuitry may include a secure cryptoprocessor, which is a dedicated system on chip (SoC) or microprocessor designed to secure hardware by carrying out cryptographic operations. An example of such embodiments is shown by FIG. 7.

As shown, the SEE 515 may include modem manager 520. The modem manager 520 may be one or more software modules that operate in conjunction with one or more hardware devices to configure the communications circuitry 505 to communicate using different wireless protocols. This may include detecting a trigger to reconfigure the communications circuitry 505, selecting a modem profile (MP) of a plurality of MPs 577 in response to the trigger, (re)configuring the communications circuitry 505 in accordance with the selected MP 577, implementing or executing applications associated with one or more network access profiles (NAPs) 575, etc. The modem manager 520 may generate messages/commands/data (MCD), which may be communicated to the proxy 510 in encrypted form. The proxy 510 may decrypt the MCD, and provide the decrypted MCD to other components of the computing platform 504. This may include providing the MCD to the communications circuitry 505 to send/receive data to/from various network elements including network elements within cloud 302, server(s) 304, and client 560. The modem manager 520 may also receive MCD in encrypted form from the proxy 510, and decrypt the MCD for use with one or more applications within the SEE 515. In embodiments where the SEE 515 is implemented using secure enclaves, the modem enclave may include a bridge application 530 that may interact with components of the modem manager 520 within the modem enclave. The bridge 530 may receive MCD from the modem manager 520 and transmit the MCD to the proxy 510. The bridge 530 may also receive MCD from the proxy 510 and provide the MCD to the modem manager 520.

Additionally, the SEE 515 may include the secure storage 525, which may include one or more databases (DBs) implemented by one or more computer-readable media of the computing platform 504. The one or more DBs may be associated with one or more applications that enable querying of the databases and/or store information in the databases. Any suitable database query language may be used to store and obtain information from secure storage 525. The secure storage 525 may be implemented in one or more data storage devices, such as those discussed with regard to FIGS. 6-7.

In various embodiments, the modem manager 520 may query the secure storage 525 to retrieve and control storage of profile data, such as MPs 577 and NAPs 575. In embodiments where the SEE 515 is implemented using secure enclaves, each of the NAPs 575, each of the MPs 577, and/or other data in the secure storage 525 may be stored in their own enclaves, which are accessible by the modem manager 520 using procedures discussed in commonly assigned and incorporated by reference Int'l App. No. PCT/US2016/037634. In embodiments where the SEE 515 is implemented using ME circuitry, the secure storage 525 (including the NAPs 575, MPs 577, and/or other sensitive data) may be implemented in one or more memory devices embedded in the ME circuitry.

The secure storage 525 may store NAPs 575 (individual ones of the NAPs 575 may be referred to as a “NAP 575” or “N NAP 575” where N is a name of the NAP). In alternative embodiments, the NAPs 575 may be stored in a UICC, eUICC, or smartcard of the computing platform 504 (not shown), which that is separate from the secure storage of the SEE 515 but is also considered a type of secure storage. Additionally or alternatively, the NAPs 575 may be stored and/or implemented by an “integrated UICC” as discussed in commonly assigned and incorporated by reference Int'l App. No. PCT/US2016/037634.

Each of the NAPs 575 may belong to a network operator and/or service provider, and when enabled, may allow the computing platform 504 to access a specific network infrastructure of the network operator or specific services provided by a service provider. Each of the NAPs 575 may include one or more elements defined by the GlobalPlatform Card specifications, GSMA standards, and/or any other like standard. These elements may include, inter alia, one or more security domains, a file system element, a network access application (NAA) (also referred to as a “subscriber identity module”, “SIM”, “SIM applet”, and the like), one or more other applications, user data, credentials, and a network/service access policy (SAP).

The security domains may be packages that support various security services, such as key handling, encryption, decryption, digital signature generation, establishment of secure channels with other devices, and verification for associated applications. Each of the NAAs (or SIMS) may be an application that is used to access a specific network operated by a network operator, the cloud 302, or server(s) 304. The NAAs may use stored user data, keys, credentials, etc. to authenticate the computing platform 504 and network infrastructure and/or services in accordance with a stored policy. In one example, a first NAP 575 may include an international mobile subscriber identity (IMSI), security keys, and other like credentials, which may be used by a corresponding first NAA to authenticate the computing platform 504 and an LTE or UMTS network. In this example the first NAA may be a UMTS SIM (USIM). The secure storage 525 may also store a plurality of NAPs 575, such as a GSM SIM (GSIM) for accessing a GSM network, a an IP Multimedia Services (IMS) SIM (ISIM) for accessing a IMS services/applications, a CDMA SIM (CSIM) for accessing a CDMA network, a Worldwide Interoperability for Microwave Access (WiMAX) SIM (WiSIM) for accessing a WiMAX network, a WiFi SIM for accessing a WiFi network, and the like. Furthermore, the SEE 515 may include different NAPs 575 for accessing a network of a same type, which may be operated by different network operators/owners. In some embodiments, at least some of the NAPs 575 may be used to authenticate the computing platform 504 with service provider infrastructure to access specific services provided by a service provider.

The NAPs 575 (and elements therein) may be provisioned and perform various functions (e.g., authentication, network attachment, and the like) as defined by various technical standards (TS), such as ISO/IEC 7816, European Telecommunications Standards Institute (ETSI) 102 221, ETSI TS 102 225, ETSI TS 102 226, ETSI TS 102 241, ETSI TS 102 600, 3rd Generation Partnership Project (3GPP) TS 31.101, 3GPP TS 31.116, 3GPP TS 31.121, 3GPP TS 31.220, 3GPP TS 31.828, Groupe Speciale Mobile Association (GSMA), “Remote Provisioning Architecture for Embedded UICC,” technical standard version 3.0, 30 Sep. 2015, and/or any other like standards. A detailed description of NAP elements, provisioning, and operations (including communication between two or more NAPs and between a NAP and a remote device) is discussed in the commonly assigned and incorporated by reference Int'l App. No. PCT/US2016/037634.

To access specific network infrastructure, at least some of the NAPs 575 may operate in conjunction with a corresponding one of the MPs 577, which may also be stored in the secure storage 525 (individual ones of the MPs 577 may be referred to as a “MP 577” or “N MP 577” where N is a name of the modem profile). Each of the MPs 577 may define a flow of digital signals through a digital circuit and logical operations performed on those signals. In various embodiments, the MPs 577 may be configured or otherwise defined using a hardware description language (HDL), such as register-transfer logic (RTL), very high speed integrated circuit (VHSIC) HDL (VHDL), Verilog, and the like. The MPs 577 may be used to dynamically configure the communications circuitry 505 (or components therein). In embodiments, the MPs 577 may be obtained from the server(s) 304 or cloud computing service and stored locally in secure storage 525. The MPs 577 provide the capability to morph the communications circuitry 505 to adapt to new geo-fence settings, NAP 575 requirements, radio link failures, QoS requirements, and the like. The MPs 577 may be provisioned in the secure storage 525 in a same or similar manner as discussed in the commonly assigned and incorporated by reference Int'l App. No. PCT/US2016/037634.

In various embodiments, the modem manager 520 may provision the communications circuitry 505 (or components therein) with a selected MP 577, which when enabled by the communications circuitry 505 (or components therein), may allow the communications circuitry 505 to process digital signals for transmission to other devices, or process received signals to be provided to other components of the computing platform 504. The modem manager 520 may select an MP 577 in accordance with an access policy (AP) 578, which may also be stored in the secure storage 525. The AP 578 may define a set of rules that govern the behavior of the manager module 520, which may include one or more conditions and/or criteria under which action(s) are executed. For example, the AP 578 may define one or more triggers (or events) to prompt the selection of a specific MP 577 based on an MP 577 that is currently enabled by the communications circuitry 505. In another example, the AP 578 may define actions to take when a network attachment procedure fails after an MP 577 is provisioned in the communications circuitry 505. In another example, the AP 578 may define actions to take when an MP 577 is incorrectly or otherwise unable to be provisioned in the communications circuitry 505. The one or more triggers may be the detection of a radio link failure (RLF) as indicated by the communications circuitry 505, receipt of an instruction/command from another component or device, falling below a threshold QoS level, falling below a threshold data rate or bandwidth allocation (e.g., as allocated to the computing platform 504 by a network element, or as defined by a data plan or subscription information), and the like.

In various embodiments, the AP 578 may be configured by a developer or administrator of the service provider that owns or deploys the computing platform 504 and/or other IoT devices 404, or developers/administrators of the service provider's customers/users (e.g., client 560) that utilizes services provided by the server(s) 304, the computing platform 504, and/or other IoT devices 404. In such embodiments, the service provider may provide a dashboard or other like user interface that allows the developers/administrators and/or customers/users to define the rules of the AP 578 and/or configure the communications circuitry 505. For example, the dashboard or user interface may be used to generate instructions or a modem configuration message, which may be included in or with the AP 578. The modem configuration message may indicate one or more MPs 577 to add, delete, and/or update to/from the secure storage 525, and/or one or more NAPs 575 to add, delete, and/or update to/from the secure storage 525. Additionally, in some embodiments, the service provider may limit or expand particular rules and/or modem configurations that users/customers may set according to service provider policies, subscription plans and/or purchases, and/or other like criteria.

Additionally or alternatively, the SEE 515 may include a selection agent 535 that may develop the AP 578 or otherwise determine the rules, conditions, or criteria for selecting/switching/adding/deleting MPs 577 and/or NAPs 575 with little or no human intervention based on business needs, data urgency, task optimizations, network and/or computer resource utilization, network traffic, location and/or position information, state information or mode of operation, contextual information, and/or other like criteria. The selection agent 535 may be configured using a machine learning model that is developed based on different deployment and/or operation scenarios, which may be used to train the behavior of the selection agent 535. In some embodiments, upon deployment of the computing platform 504, the selection agent 535 may create a decision tree that shows different connection availability in the presence of data that needs to be transmitted to a backend service (e.g., server(s) 304). The decision tree may include with a branches for critical data/services and branches for non-critical data/services. In some embodiments, the computing platform 504 implementing the selection agent 535 may provide the decision tree to a user of client 560 for selection of critical and/or non-critical data/services. In such embodiments, the selection agent 535 may be trained based on the user selections, and a machine learning model may be packaged inside the computing platform 504. This may allow the computing platform 504 to be self-sufficient, especially in scenarios where the computing platform 504 is deployed in a difficult-to-access area, or when human/user intervention is not scalable.

The selection agent 535 may not need to exist on every IoT device 404 or computing platform 504 in a given environment. Rather, the selection agent 535 may be implemented in critical nodes (e.g., an IoT device(s) 404 that is/are attached to large trucks in a mining operation, an IoT device 404 embedded in a robot arm in a factory, etc.), an aggregation node (e.g., aggregators 406 discussed previously), control node (e.g., an IoT device or computer device that controls other IoT devices in a given environment), and the like.

Still referring to FIG. 5, the server(s) 304 may comprise one or more hardware computer devices and/or network elements for providing one or more services for client 560. These services may utilize the data captured and reported by the computing platform 504 and/or IoT devices 404. The server(s) 304 may obtain event based data from the IoT devices 404, analyze the event-based data, and may be able to generate content such as text, graphics, audio and/or video to be transferred to client 560, via a web server (not shown) in the form of HTML, XML, ASP, MPEG-DASH, Java™, JSP, PHP, and/or any other appropriate structured language or server-side scripting language. The handling of requests and responses, (e.g., requests for information/content and the information/content provided in response) may be handled by the web server (not shown). In various embodiments, the server(s) 304 may be implemented as a broker system (also referred to as a “cloud broker”, “cloud service provider”, “cloud SIM broker”, and the like) that provides users/customers with the ability to log-in and manage an array of NAPs 575 across one or more devices, such as the computing platform 504 and one or more other IoT device 404, using a dashboard or other like user interface. The users/customers may use the dashboard or other like user interface to define the AP 578 as discussed previously, and/or to manage desired services, subscriptions/purchases, etc. Based on a chosen configuration, appropriate device-specific configuration(s) may be generated and updated on the computing platform 504 and one or more other IoT device 404.

The server(s) 304 may include an operating system (OS) that may provide executable program instructions for the general administration and operation of servers, and may include a computer-readable medium storing instructions that, when executed by a processor of the servers, may allow the servers to perform their intended functions. Suitable implementations for the OS and general functionality of servers are known or commercially available, and are readily implemented by persons having ordinary skill in the art. Additionally, the server(s) 304 may comprise a single physical hardware device, or may be physically or logically connected with other network devices, such that the server(s) 304 may reside on one or more physical hardware devices. Moreover, the server(s) 304 may be connected to, or otherwise associated with, one or more data storage devices (not shown).

Client 560 may be a physical hardware device that is capable of running one or more applications for controlling and/or communicating with the server(s) 304, computing platform 504, and/or one or more IoT devices 404. These applications may be native applications, web applications, and/or hybrid applications. Client 560 may include a transmitter/receiver (or alternatively, a transceiver or RF circuitry), memory, one or more processors, one or more sensors (e.g., accelerometers, gyroscopes, image sensors, Global Positioning System (“GPS”) receiver, etc.), and/or other like components. Client 560 may communicate (transmit/receive) data with one or more IoT devices 104 via cloud 302 and/or GW 310, and communicate data with server(s) 304 via cloud 302. Client 560 may communicate with the various devices in arrangement 50 in accordance with one or more wireless or wired communications protocols as discussed herein. Client 560 may communicate with one or more IoT device 404 and computing platform 504 in accordance with one or more wireless communications protocols as discussed herein. Client 560 may be a desktop personal computer (PC), laptop PC, a wireless cellular phone or smartphone, a tablet PC, a wearable computer device, a handheld messaging device, a personal data assistant, an electronic book reader, an augmented reality head-mounted (or helmet-mounted) display device, and/or any other physical or logical device capable of recording, storing, and/or transferring digital data.

FIG. 6 illustrates a first example implementation of a computing platform, in accordance with various embodiments. FIG. 6 shows a block diagram of an example of components that may be present in a computing platform 504. The computing platform 504 may include any combinations of the components shown in the example. The components may be implemented as ICs, portions thereof, discrete electronic devices, or other modules, logic, hardware, software, firmware, or a combination thereof adapted in the computing platform 504, or as components otherwise incorporated within a chassis of a larger system. The block diagram of FIG. 6 is intended to show a high level view of components of the computing platform 504. However, some of the components shown may be omitted, additional components may be present, and different arrangement of the components shown may occur in other implementations.

The computing platform 504 may include a processor 802, which may be a microprocessor, a multi-core processor, a multithreaded processor, an ultra-low voltage processor, an embedded processor, or other known processing element. The processor 802 may be a part of a system on a chip (SoC) in which the processor 802 and other components are formed into a single integrated circuit, or a single package, such as the Edison™ or Galileo™ SoC boards from Intel. As an example, the processor 802 may include an Intel® Architecture Core™ based processor, such as a Quark™, an Atom™, an i3, an i5, an i7, or an MCU-class processor, or another such processor available from Intel® Corporation, Santa Clara, Calif. However, any number other processors may be used, such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters. The processors may include units such as an A5-A9 processor from Apple® Inc., a Snapdragon™ processor from Qualcomm® Technologies, Inc., or an OMAP™ processor from Texas Instruments, Inc.

The processor 802 may communicate with a system memory 804 over a bus 806. Any number of memory devices may be used to provide for a given amount of system memory. As examples, the memory can be random access memory (RAM) in accordance with a Joint Electron Devices Engineering Council (JEDEC) low power double data rate (LPDDR)-based design such as the current LPDDR2 standard according to JEDEC JESD 209-2E (published April 2009), or a next generation LPDDR standard, such as LPDDR3 or LPDDR4 that will offer extensions to LPDDR2 to increase bandwidth. In various implementations the individual memory devices may be of any number of different package types such as single die package (SDP), dual die package (DDP) or quad die package (Q17P). These devices, in some embodiments, may be directly soldered onto a motherboard to provide a lower profile solution, while in other embodiments the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs. For example, a memory may be sized between 2 GB and 16 GB, and may be configured as a DDR3LM package or an LPDDR2 or LPDDR3 memory, which is soldered onto a motherboard via a ball grid array (BGA).

To provide for persistent storage of information such as data, applications, operating systems and so forth, a mass storage 808 may also couple to the processor 802 via the bus 806. To enable a thinner and lighter system design the mass storage 808 may be implemented via a solid state disk drive (SSDD). Other devices that may be used for the mass storage 808 include flash memory cards, such as SD cards, microSD cards, xD picture cards, and the like, and USB flash drives. In low power implementations, the mass storage 808 may be on-die memory or registers associated with the processor 802. However, in some examples, the mass storage 808 may be implemented using a micro hard disk drive (HDD). Further, any number of new technologies may be used for the mass storage 808 in addition to, or instead of, the technologies described, such resistance change memories, phase change memories, holographic memories, or chemical memories, among others. For example, the computing platform 504 may incorporate the 3D XPOINT memories from Intel® and Micron®.

The operating systems (OSs) may be a general purpose operating system or an operating system specifically written for and tailored to the computing platform 504. The OSs may include one or more libraries or APIs, which provide program code and/or software components for one or more applications to obtain and use the data from the secure execution environment 515 and/or the ME circuitry 850.

In the embodiment depicted by FIG. 6, the memory 804 and/or storage 808 may be divided into one or more trusted memory regions for storing applications or software modules of the SEE 515. These trusted memory regions may be hardware enforceable containers called enclaves, secure enclaves, and the like. The enclaves may be one or more isolated regions of memory 804 and/or storage 808 that are encrypted within the memory 804 and/or storage 808, and only decrypted inside the processor 802. The secure enclaves may be used to store security critical code and/or data, such as modem manager 520, NAPs 375, access policies 578, selection agent 35, and/or an enclave OS (not shown). The memory 804 and/or storage 808 may be divided into multiple enclaves, wherein a modem enclave may include the modem manager 520 and other enclaves may include each of the NAPs 575, MPs 577, APs 578, and selection agent 535. From a physical point of view, enclave data is resident within registers, caches, and/or other logic blocks inside the application circuitry or host architecture (e.g., processor 802, memory 804, storage 808, etc.). Unauthorized access via untrusted software is prevented by processor logic. Whenever enclave data leaves the on-package caches to be written to memory 804 and/or storage 808, the data is automatically encrypted and integrity protected, which reduces the likelihood enclave data will be viewed, modified, or replayed. In some embodiments, the enclaves may be defined and managed by a virtual machine monitor (VMM) of a virtual machine running as a guest OS. Any suitable VMM may be used to define the secure enclaves. In various embodiments, the SEE 515 may be one or more secure enclaves defined using the Intel® SGX instructions. A detailed discussion of enclave establishment and operation (including communication between two or more enclaves, and between an enclave and remote devices) is discussed in the commonly assigned and incorporated by reference Int'l App. No. PCT/US2016/037634.

The components may communicate over the bus 806. The bus 806 may include any number of technologies, including industry standard architecture (ISA), extended ISA (EISA), peripheral component interconnect (PCI), peripheral component interconnect extended (PCIx), PCI express (PCIe), or any number of other technologies. The bus 806 may be a proprietary bus, for example, used in a SoC based system. Other bus systems may be included, such as an I²C interface, an SPI interface, point to point interfaces, and a power bus, among others.

The bus 806 may couple the processor 802 to the modem circuitry 840 (also referred to as “baseband circuitry 840”, “modem 840”, and the like) for communications with other devices. The modem 840 may include circuitry such as, but not limited to, one or more a field-programmable devices (FPDs) such as FPGAs and the like; programmable logic devices (PLDs) such as complex PLDs (CPLDs), high-capacity PLDs (HCPLDs), and the like; ASICs such as structured ASICs and the like; programmable SoCs (PSoCs); etc. The circuitry of modem 840 may comprise logic blocks or logic fabric including, but not limited to, configuration logic 841, user logic 842, and update logic 843; memory cells 844, input/output (I/O) blocks (not shown), and other interconnected resources that may be programmed to perform various modem functions, such as processing signals received from a receive signal path of the transceivers 810, 811, and generating signals for a transmit signal path of the transceivers 810, 811. Modem 840 may interface with the application circuitry of the computing platform 504 for generation and processing of the signals and for controlling operations of the transceivers 810, 811.

For example, in various embodiments, the circuitry of the modem 840 may be provisioned with an MP 577 by the modem manager 520. As discussed previously, the MP 577 may be configured or otherwise defined using an HDL, such as RTL, VHDL, Verilog, and the like. The provisioning may include the MP 577 being loaded into the memory cells 844 by the modem manager 520 via the proxy 510. The memory cells 844 may be used to store data in lookup-tables (LUTs), such as a provisioned MP 577, that are used by the modem 840 to implement various logic functions. Memory cells 844 may include any combination of suitable volatile memory and/or non-volatile memory. The memory cells 844 may include any combination of various levels of memory/storage including, but not limited to, erasable programmable read-only memory (EPROM), electrically erasable programmable read-only memory (EEPROM), flash memory, static memory (e.g., static random access memory (SRAM), anti-fuses, etc.

The provisioning may also include the update logic 843 obtaining the MP 577 from the memory cells 844, and applying the MP 577 to the configuration logic 841. In embodiment, the user logic 843 may be used to ensure that the MP 577 is applied to the configuration logic 841 per user the AP 578 as discussed previously. Once the MP 577 is enabled, the configuration logic 841 may define a set of signal paths and a set of logical operations to be performed on the signal paths, which may be used to handle various radio control functions that enable communication with one or more radio networks via the transceivers 810, 811 according to one or more particular wireless communications protocols. The radio control functions may include, but are not limited to, signal modulation/demodulation, encoding/decoding, radio frequency shifting, implementing protocol stacks, and the like. In some embodiments, modulation/demodulation by the modem 840 may include Fast-Fourier Transform (FFT), precoding, and/or constellation mapping/demapping functionality. In some embodiments, encoding/decoding circuitry of the modem 840 may include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments. The modem 840 may pass demodulated signals obtained from the transceivers 810, 811 to other components of the computing platform 504, and may pass modulated signals to the transceivers 810, 811 for transmission to other devices.

The mesh transceiver 810 may be used for communications with other mesh devices 812, which may be included in a fog as discussed previously. The mesh transceiver 810 may use any number of frequencies and protocols. For example, when the modem 840 is configured with an IEEE 802.15.4 standard MP 577, the mesh transceiver 810 may transmit/receive signals in the 2.4 gigahertz (GHz) range as specified by the IEEE 802.15.4 standard. Upon detection of a trigger, the modem 840 may be configured to utilize other wireless communications protocols for communicating with mesh devices 812, such as the Bluetooth® low energy (BLE) standard, as defined by the Bluetooth® Special Interest Group, or the ZigBee® standard, among others. The modem 840 may be configured for any particular wireless communications protocol for the connections to the mesh devices 812. For example, a WLAN MP 577 may be used to implement Wi-Fi™ communications in accordance with the Institute of Electrical and Electronics Engineers (IEEE) 802.11 standard. In addition, wireless wide area communications, for example, according to a cellular or other wireless wide area protocol, can occur via a wireless wide area network (WWAN) MP 577 or via a specific cellular network MP 577.

The mesh transceiver 810 may include multiple radios (e.g., including hardware devices such as switches, filters, amplifiers, antenna elements, and the like to facilitate the communications over the air) to communicate using multiple standards for communications at different range. For example, the computing platform 504 may communicate with close devices (e.g., within about 10 meters) using a local transceiver based on BLE, or another low power radio, to save power. More distant mesh devices 812 (e.g., within about 50 meters) may be reached over ZigBee or other intermediate power radios. Both communications techniques may take place over a single radio at different power levels, or may take place over separate transceivers/radios, for example, a local transceiver/radio using BLE and a separate mesh transceiver/radio using ZigBee. Utilizing different wireless communications protocols may or may not include utilizing different radios within the mesh transceiver 810. The mesh transceiver 810 may be incorporated into an MCU as an address directly accessible by the chip, such as in the Curie® units available from Intel.

A cloud transceiver 811 may include one or more radios to communicate with devices in the cloud 302. For example, when the modem 840 is configured with an LPWA MP 577 that follows the IEEE 802.15.4 or IEEE 802.15.4g standards, among others, the cloud transceiver 811 may transmit/receive signals in the 2.4 GHz range as specified by the IEEE 802.15.4/g standards. Upon detection of a trigger, the modem 840 may be configured to utilize other wireless communications protocols for communicating over the cloud 302, such as LoRaWAN™ (Long Range Wide Area Network) developed by Semtech and the LoRa Alliance, one or more WiFi protocols, and/or one or more cellular protocols discussed herein. Utilizing different wireless communications protocols may or may not include utilizing different radios within the cloud transceiver 811. The techniques described herein are not limited to these technologies, but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the mesh transceiver 810 and uplink transceiver 811, as described herein. For example, the radio transceivers 810 and 811 may include an LTE or other cellular transceiver that uses spread spectrum (SPA/SAS) communications for implementing high speed communications, such as for video transfers. Further, any number of other protocols may be used, such as Wi-Fi® networks for medium speed communications, such as still pictures, sensor readings, and provision of network communications.

The transceivers 810 and 811 may include radios that are compatible with any number of 3GPP (Third Generation Partnership Project) specifications, notably Long Term Evolution (LTE), Long Term Evolution-Advanced (LTE-A), and Long Term Evolution-Advanced Pro (LTE-A Pro). It can be noted that radios compatible with any number of other fixed, mobile, or satellite communication technologies and standards may be selected. These may include, for example, any Cellular Wide Area radio communication technology, which may include e.g. a 5th Generation (5G) communication systems, a Global System for Mobile Communications (GSM) radio communication technology, a General Packet Radio Service (GPRS) radio communication technology, or an Enhanced Data Rates for GSM Evolution (EDGE) radio communication technology. Other Third Generation Partnership Project (3GPP) radio communication technology that may be used includes UMTS (Universal Mobile Telecommunications System), FOMA (Freedom of Multimedia Access), 3GPP LTE (Long Term Evolution), 3GPP LTE Advanced (Long Term Evolution Advanced), 3GPP LTE Advanced Pro (Long Term Evolution Advanced Pro)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+ (High Speed Packet Access Plus), UMTS-TDD (Universal Mobile Telecommunications System-Time-Division Duplex), TD-CDMA (Time Division-Code Division Multiple Access), TD-SCDMA (Time Division-Synchronous Code Division Multiple Access), 3GPP Rel. 8 (Pre-4G) (3rd Generation Partnership Project Release 8 (Pre-4th Generation)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP LTE Extra, LTE Licensed-Assisted Access (LAA), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), Wireless Gigabit Alliance (WiGig) standard, mmWave standards in general (wireless systems operating at 10-90 GHz and above such as WiGig, IEEE 802.11ad, IEEE 802.11ay, and the like. In addition to the standards listed above, any number of satellite uplink technologies may be used for the uplink transceiver 811, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated.

A network interface controller (NIC) 816 may be included to provide a wired communication to the cloud 302 or to other devices, such as the mesh devices 812. The wired communication may provide an Ethernet connection, or may be based on other types of networks, such as Controller Area Network (CAN), Local Interconnect Network (LIN), DeviceNet, ControlNet, Data Highway+, PROFIBUS, or PROFINET, among many others. An additional NIC 816 may be included to allow connect to a second network, for example, a NIC 816 providing communications to the cloud over Ethernet, and a second NIC 816 providing communications to other devices over another type of network.

The bus 806 may couple the processor 802 to an interface 818 that is used to connect external devices. The external devices may include sensors 820, such as accelerometers, level sensors, flow sensors, temperature sensors, pressure sensors, barometric pressure sensors, and the like. The interface 818 may be used to connect the computing platform 504 to electro-mechanical components (EMCs) 822, which may allow computing platform 504 to change its state, position, and/or orientation, or move or control a mechanism or system. The EMCs 822 may include one or more power switches, actuators (e.g., valve actuators), an audible sound generator, a visual warning device, motors, wheels, thrusters, propellers, claws, clamps, hooks, and/or other like electro-mechanical components. In embodiments, computing platform 504 may be configured to operate one or more EMCs 822 based on one or more captured events and/or instructions or control signals received from a service provider (e.g., an operator of the server(s) 304) and/or client 560. Additionally, the interface 818, sensors 820, and EMCs 822 may be collectively referred to as “event capture circuitry 540.” In some embodiments, the event capture circuitry 540 may also battery monitor/charger 826, the processor 802, and/or other components in or coupled with platform 504.

ME circuitry 850 may be an isolated and tamper-resistant chipset, which is distinct from and generally operates independently of the processor 802. The ME circuitry 850 may be embodied as any number of hardware, firmware, and/or software modules configured to perform security, encryption, and/or authentication functions, as described herein. In some embodiments the ME circuitry 850 may be included in a graphics controller or graphics processing unit (GPU). In some embodiments, the ME circuitry 850 may be integrated into the application circuitry (e.g., a same circuit board or SoC as processor 802 and/or memory 804, etc.) or the communications circuitry 505 (e.g., a same circuit board or SoC as the modem circuitry 840, etc.). The ME circuitry 850 may additionally or alternatively include separate circuitry disposed on another circuit board or SoC that is communicatively coupled to the application circuitry and/or communications circuitry 505 via a signal path, such as bus 806. The ME circuitry 850 may be communicatively coupled to other components of the application circuitry via bus 806 and communicatively coupled to the communications circuitry 505 of the computing platform 504 via a separate bus, such as a private low pin count (LPC) serial bus the LPC serial bus that is not exposed to a host OS of the application circuitry.

ME circuitry 850 may include ME processor 852 and ME memory 854. ME memory 854 may store crypto operations 855, which is a set of cryptographic algorithms or operations used for generating keys 856 and encrypting/decrypting data. The keys 856 may be used to encrypt/decrypt data being communicated through the ME circuitry 850. In some embodiments, the keys 856 may be generated based on one or more measurements of the application circuitry. However, any suitable algorithm or operations may be used for key generation and/or encrypting/decrypting data. ME processor 852 may be any processing device capable of executing software modules or program code independently of the other processors of the application circuitry and may include tamper-resistant characteristics. ME processor 852 may include one or more microprocessors, DSPs, cryptoprocessors, secure cryptoprocessors, cryptographic accelerators, secure controllers, and/or any other suitable device. The ME memory 854 may be embodied as one or more volatile and/or non-volatile memory devices. The ME memory 854 may store various data, including software/firmware executable by the ME processor 852 and data used for the various cryptographic operations, such as program code for proxy 510, program code for an ME OS (not shown), keys 856, and crypto operations 855, and/or the like.

ME processor 852 may implement an ME OS, which may be a framework that provides OS like functionality to trusted applications (for example, proxy 510), and provides an API for client applications (for example, modem manager 520 or applications of the communications circuitry 505) to access trusted applications. The ME OS may also include internal ME APIs or libraries, such as a cryptographic operations API to provide cryptographic capabilities (for example, the cryptographic algorithms/operations of crypto operations 855) to trusted applications, a trusted storage API to provide trusted storage for keys 856 and other data, and a secure element API that provides mechanisms for an application to open a connection with a secure element, such as the modem manager 520, and/or to open a logical channel with an NAP 575, an NAA, or other like profile application in order to send/receive application data protocol units (APDUs) to/from the NAP 575, NAA, etc. In some embodiments, the ME OS may also include firmware or drivers that provide override mechanisms for tamper-resistant hardware devices, and firmware or drivers for verifying digital certificates, etc. These firmware modules may ensure that various conditions are met before any new applications are provisioned within the ME circuitry 850 (e.g., when the proxy 510 is provisioned within the ME circuitry 850 by a remote provisioning service). In some embodiments, the ME OS may include firmware modules for signing and verifying certificates using a certificate signing key pair. The firmware modules may verify a digital signature of certificates using a public key of the certificate signing key pair, and the private key of the certificate signing key pair is used by the security assist server to sign the certificates. The private key of this key pair may be stored in a secure data store associated with a remote provisioning service, and the public key of the key pair may be maintained in memory 854 as a firmware image that cannot be changed or altered (e.g., as one of the keys 856). In some embodiments, the ME OS may be any suitable OS or firmware, such as a real-time OS (RTOS) and the like.

ME processor 852 may also implement the proxy 510. The proxy 510 may be a collection of software modules and/or program code (for example, an applet) that enables components of the computing platform 504 to access data from the modem enclave within SEE 515. The proxy 510 may be a trusted application from the perspective of the ME circuitry 850. Trusted applications are applications that run inside the ME circuitry 850 and provide security related functionality to one or more client applications outside of the ME circuitry 850. For example, in the embodiment of FIG. 6, modem manager 520 and one or more applications operated by the communications circuitry 505 may be considered untrusted applications from the perspective of the ME circuitry 850 (by contrast, from the perspective of the modem enclave the modem manager 520 may be considered a trusted application and the proxy 510 may be considered an untrusted application). The proxy 510 may present itself as an end-point to the communications circuitry 505 in accordance with ISO 7816 protocols, GSMA protocols, GlobalPlatform protocols, and/or other like protocols, which may be used to communicate data between the NAPs 575 and remote devices. The proxy 510 may provide access to the modem manager 520 and NAPs 575 by performing the crypto operations 855 and creating a secure channel (also referred to as an “out-of-band” or OOB channel and the like) between the communications circuitry 505 and the modem enclave and enclaves containing one or more NAPs 575. The secure channel may also include an end-to-end encrypted tunnel between an enclave and one or more network elements, such as the client 560, the server(s) 304, one or more network elements associated with the cloud 302, and the like.

In an alternative embodiment, the proxy 510 may be stored in mass storage 808 or memory 804, and may be implemented by the processor 804 instead of the ME circuitry 850. In such embodiments, the proxy 510 may still act as a secure application for providing access to the modem enclave within the SEE 515. In this way, the proxy 510 may provide a secure channel for forwarding commands/instructions between the modem circuitry 840 and the modem manager 520, and between the modem circuitry 840 and the NAPs 575, in accordance with relevant specifications, such as ISO 7816 protocols, GSMA protocols, GlobalPlatform protocols, and/or other like protocols discussed herein.

In some embodiments, the ME circuitry 850 may operate in accordance with the International Organization for Standardization (ISO) and International Electrotechnical Commission (IEC) specification ISO/IEC 11889:2009, which defines standards for trusted computing platforms. In embodiments, the ME circuitry may be a management engine provided by Intel®, a Converged Security Engine (CSE) or a Converged Security Management/Manageability Engine (CSME) provided by Intel®; Trusted Execution Technology (TXT) provided by Intel®; and/or the like. In some embodiments, the ME circuitry may operate in conjunction with Active Management Technology (AMT) provided by Intel® and/or Intel® vPro™ Technology (vPro). The Intel® AMT and/or Intel® vPro™ may allow for remote provisioning of the ME circuitry, and remote management of the ME circuitry once the ME circuitry has been successfully provisioned.

While not shown, various input/output (I/O) devices may be present within, or connected to, the computing platform 504. For example, a display may be included to show information, such as sensor readings or actuator position. An input device, such as a touch screen or keypad may be included to accept input. In another example, near-field communication (NFC) circuitry comprising an NFC controller coupled with an antenna element and a processing device may be included to read electronic tags and/or connect with another NFC-enabled device.

A battery 824 may power the computing platform 504, although in examples in which the computing platform 504 is mounted in a fixed location, it may have a power supply coupled to an electrical grid. The battery 824 may be a lithium ion battery, a metal-air battery, such as a zinc-air battery, an aluminum-air battery, a lithium-air battery, and the like.

A battery monitor/charger 826 may be included in the computing platform 504 to track the state of charge (SoCh) of the battery 820. The battery monitor/charger 826 may be used to monitor other parameters of the battery 824 to provide failure predictions, such as the state of health (SoH) and the state of function (SoF) of the battery 824. The battery monitor/charger 826 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 826 may communicate the information on the battery 824 to the processor 802 over the bus 806. The battery monitor/charger 826 may also include an analog-to-digital (ADC) convertor that allows the processor 802 to directly monitor the voltage of the battery 826 or the current flow from the battery 824. The battery parameters may be used to determine actions that the computing platform 504 may perform, such as transmission frequency, mesh network operation, sensing frequency, and the like.

A power block 828, or other power supply coupled to a grid, may be coupled with the battery monitor/charger 826 to charge the battery 824. In some examples, the power block 828 may be replaced with a wireless power receiver to obtain the power wirelessly, for example, through a loop antenna in the computing platform 504. A wireless battery charging circuit, such as an LTC4020 chip from Linear Technologies of Milpitas, Calif., among others, may be included in the battery monitor/charger 826. The specific charging circuits chosen depend on the size of the battery 824, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The mass storage 808 may include a number of modules to implement the group creation functions described herein. Although shown as code blocks in the mass storage 808, it may be understood that any of the modules may be replaced with hardwired circuits, for example, built into an ASIC, FPGA, and the like. The mass storage 808 may include a sub-object list 830 of atomic objects and composite objects that may be used to form a group object. A collection group identifier 832 may use the sub-object list 830 to generate a group ID, for example, using a hash formula on the sub-object list 830. The mass storage 808 may also include the SEE 515 and the modules therein as shown by FIG. 6, which may operate as described previously.

FIG. 7 illustrates the components of a second implementation of the computing platform 504, in accordance with various embodiments. As shown by FIG. 7, computing platform 504 may include similar components as shown by FIG. 6, such as processor 802, memory 804, ME circuitry 850, bus 806, communications circuitry 505 including modem circuitry 840 and transceivers 810 and 811, NIC 816, interface 818, storage 808, battery 824, and battery monitor 826, each of which may operate in a same or similar manner as discussed with regard to FIG. 6. However, according to the example embodiment shown by FIG. 7, the proxy 510 and the modem manager 520 may be included in the ME memory 854 and implemented by the ME processor 852 of the ME circuitry 850. In such embodiments, the ME circuitry 850 may act as the SEE 515 without the need to implement secure enclaves. In some embodiments, the proxy 510 may forward commands or instructions between the modem circuitry 840 and the modem manager 520 and NAPs 575 in accordance with relevant specifications, such as ISO 7816 protocols, GSMA protocols, GlobalPlatform protocols, and/or other like protocols. In other embodiments, the proxy 510 may be omitted, and the modem manager 520 may communicate with the modem circuitry 850 over an OOB channel in accordance with one or more standards relevant to secure/trusted execution environments.

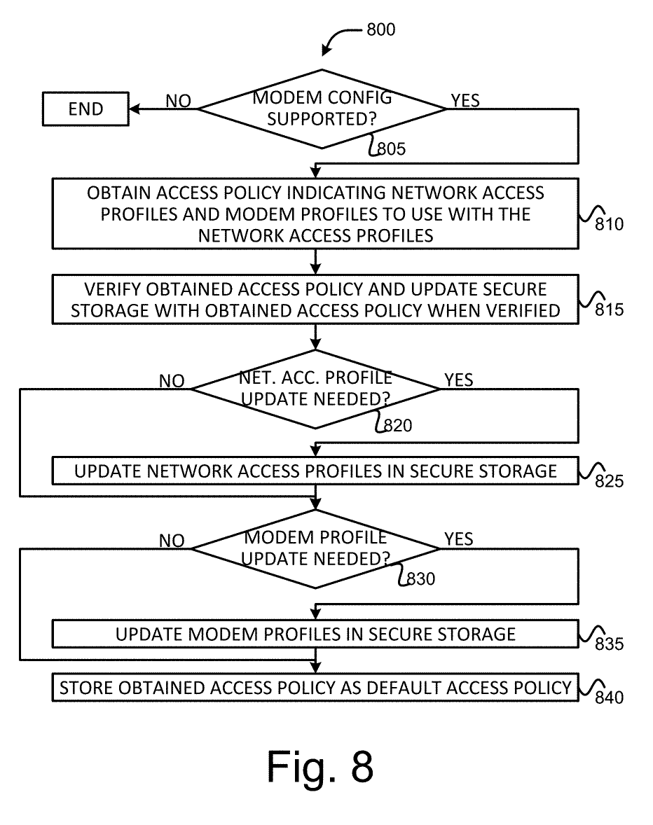

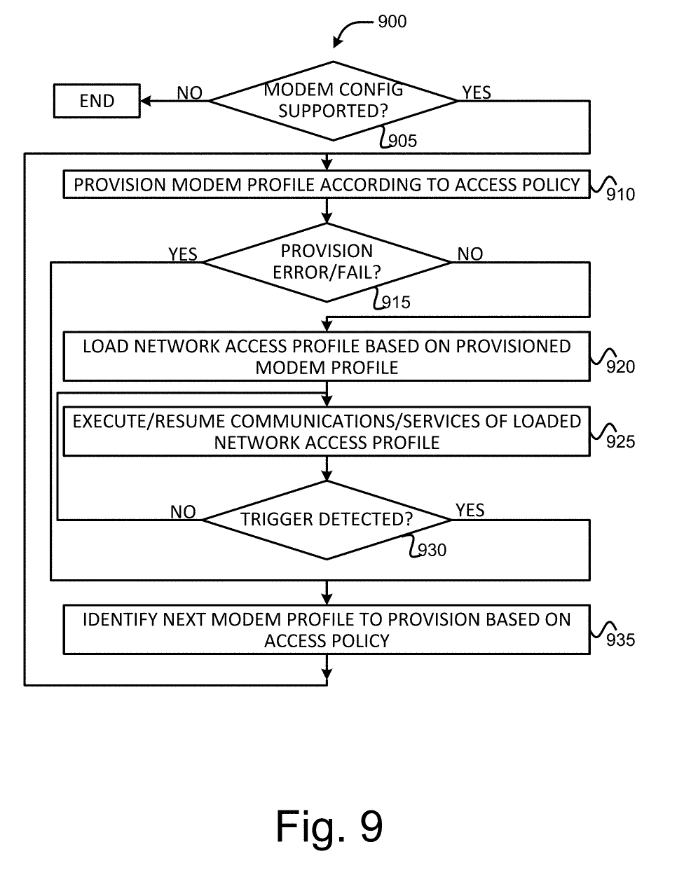

FIGS. 8-9 illustrate processes 800-900 for provisioning and implementing the modem manager 520 in accordance with various embodiments. For illustrative purposes, the operations of processes 800-900 are described as being performed by the various elements as described with respect to FIGS. 1-7. Some of the operations in processes 800-900 are described as being between modem manager 520 and other components/modules of computing platform 504 and/or a remote platform, such as cloud 302, a cloud broker or servers 304, client 560, and the like. It should be understood that such communications between computing platform 504 and components/modules/remote devices may be facilitated by the proxy 510 and/or communications circuitry 505 as described with regard to FIGS. 1-7. Furthermore, prior to operating processes 800-900, the modem manager 520 (and other components/modules shown by FIGS. 5-7) may be provisioned in the computing platform 504 in a same or similar manner as discussed in the commonly assigned and incorporated by reference Int'l App. No. PCT/US2016/037634. Moreover, while particular examples and orders of operations are illustrated in FIGS. 8-9, the depicted orders of operations should not be construed to limit the scope of the embodiments in any way. Rather, the depicted operations may be re-ordered, broken into additional operations, combined, and/or omitted altogether while remaining within the spirit and scope of the present disclosure.

Referring to the figures, FIG. 8 is a flowchart illustrating an example process 800 for configuring the modem manager 520, in accordance with various embodiments. Process 800 may be invoked by a user (e.g., operator of client 560) (or a program) to implement desired connection functionality in computing platform 504, IoT devices 404, or other suitable devices. Process 800 may be advantageous for configuring devices, such as IoT device 404, M2M, or MTC devices, which are not easily reachable. However, process 800 may also be used for configuring other devices over the air (OTA).

Process 800 may begin at operation 805 where the modem manager 520 may determine whether modem configuration functionality is supported. If at operation 805 the modem manager 520 determines that the modem configuration functionality is not supported by the computing platform 504, then the process 800 may end. If at operation 805 the modem manager 520 determines that the modem configuration functionality is supported by the computing platform 504, then the modem manager 520 may proceed to operation 810. At operation 810, the modem manager 520 may obtain an AP 578 indicating one or more NAPs 575 and MPs 577 to use with the NAPs 575. In embodiments, the AP 578 may be defined by a client 560 and may be obtained in a configuration message from a cloud broker system. In some embodiments, the configuration message may also include a modem configuration, which may indicate one or more MPs 577 and/or one or more NAPs 575 to add, delete, or update. In embodiments, receipt of the modem configuration message may be based on a request for the modem configuration message sent by the computing platform 504, which may be sent on a periodic basis or in response to a predetermined or configured event/trigger. In other embodiments, the AP 578 may be obtained from a selection agent 535.

At operation 815, the modem manager 520 may verify the obtained AP 578 (and/or modem configuration) and update the secured storage 525 with the obtained AP 578 (and/or any additional MPs 577 and/or NAPs 575) when verified. In some embodiments, this operation may be omitted in embodiments where the selection agent 535 provides the AP 578. In some embodiments, the verification of the AP 578 may include determining whether the rules in AP 578 are capable of being implemented or whether they are permitted. This may include checking the rules in AP 578 against subscription information, which may be provided by various network operators or service providers. In some embodiments, the verification of the AP 578 may include performing various security procedures, such as a suitable handshake operation, a remote or local attestation procedure, such as the remote and local attestation procedures discussed in the commonly assigned and incorporated by reference Int'l App. No. PCT/US2016/037634, and the like.

At operation 820, the modem manager 520 may determine whether a NAP 575 update is needed, for example, based on a modem configuration obtained at operation 810. If at operation 820, the modem manager 520 determines that a NAP 575 update is needed, the modem manager 520 may proceed to operation 825 to update any NAPs 575 in secure storage 525. These updates may include updated/editing existing NAPs 575, provisioning new NAPs 575, and/or deleting existing NAPs 575. After updating the NAPs 575, the modem manager 520 may proceed to operation 830 to determine whether any MPs 577 updates are needed.

If at operation 820, the modem manager 520 determines that no NAP 575 updates are needed, the modem manager 520 may proceed to operation 830 to determine whether any MPs 577 updates are needed, for example, based on a modem configuration obtained at operation 810. If at operation 830, the modem manager 520 determines that an MP 577 update is needed, the modem manager 520 may proceed to operation 835 to update any MPs 577 in secure storage 525. These updates may include updated/editing existing MPs 577, provisioning new MPs 577, and/or deleting existing MPs 577. After updating the MPs 577, the modem manager 520 may proceed to operation 840. If at operation 530, the modem manager 520 determines that no MP 577 updates are needed, then the modem manager 520 may proceed to operation 840 to store the obtained AP 578 in the secure storage 525 and set that AP 578 as a default access policy. After operation 840, the process 800 may end or repeat as necessary.

Referring now to FIG. 9, which is a flowchart illustrating an example process 900 for operating the modem manager 520, in accordance with various embodiments. Process 900 may be used by a user or program (e.g., the selection agent 535) to configure modem circuitry 840 based on various deployment scenarios. Furthermore, process 900 may operate concurrently with process 800 of FIG. 8.

Process 900 may begin at operation 905 where the modem manager 520 may determine whether modem configuration functionality is supported. If at operation 905 the modem manager 520 determines that the modem configuration functionality is not supported by the computing platform 504, then the process 900 may end. If at operation 905 the modem manager 520 determines that the modem configuration functionality is supported by the computing platform 504, then the modem manager 520 may proceed to operation 910.

At operation 910, the modem manager 520 may provision a first (or default) MP 577 in the modem circuitry 840 as defined by the AP 578. At operation 915, the modem manager 520 may determine whether there were any errors in provisioning of the first MP 577 and/or whether the provisioning procedure failed. If at operation 915, the modem manager 520 determines that the provisioning procedure had errors or failed, then the modem manager 520 may proceed to operation 930 to identify a second (next) MP 577 to provision in accordance with the AP 578. In some embodiments, the modem manager 520 may attempt to re-provision the first MP 577 a predefined number of times before proceeding to operation 930, which may be dependent on the type of errors/failures in the provisioning procedure. The predefined number of times and other such criteria may be defined by AP 578.

If at operation 915, the modem manager 520 determines that the provisioning procedure did not have errors or fail, then the modem manager 520 may proceed to operation 920 to load a first NAP 575 associated with the first MP 577. At operation 920 the modem manager 520 may execute communications and/or services of the loaded NAP 575. Operation 920 may include performing a network attachment procedure, as well as any associated authentication procedures, using an NAA stored with the first NAP 575 and based on any credentials or other like data stored in/with the first NAP 575. The attachment and/or authentication procedures may be those defined by a wireless communications protocol of the first NAP 575. Further, such procedures may include signaling with various network elements, where the modulation/demodulation of such signals may be performed by the modem circuitry 840 configured with the first MP 577.

At operation 930, the modem manager 930 may determine whether a trigger (or event) has been detected or otherwise identified. In embodiments, the trigger or event may be configured by a user as delineated by the AP 578, which may be received from the server(s) 304. In some embodiments, the trigger or event may be an instruction provided to the modem manager 520 by the selection agent 535, which may provide the instruction based on the generated AP 578. If at operation 930 the modem manager 520 does not detect/identify a trigger, then the modem manager 520 may loop back to operation 925 to resume communications/services of the loaded NAP 575. If at operation 930 the modem manager 520 does detect/identify a trigger, then the modem manager 520 may proceed to operation 935 to identify or select a next MP 577 to provision in the modem circuitry 840 in accordance with the AP 578. After operation 935, the modem manager 520 may proceed back to operation 910 to provision the identified/selected MP 577. The process 900 may end or repeat as necessary.

In embodiments, the next MP 577 that is identified/selected and provisioned may be based on the type of trigger that is detected. For example, if the MP 577 and NAP 575 are profiles that utilize the WiFi protocol and if the trigger detected at operation 930 is an RLF, the next MP 577 that is selected for provisioning may be a cellular network MP 577 so that captured/recorded data may be reported to a backend service (e.g., server(s) 304).

In another example, if the trigger detected at operation 930 is an error or provisioning failure message (e.g., based on operation 915), the next MP 577 that is selected for provisioning may be a short-range communications MP 577 (e.g., Bluetooth/BLE, Thread, etc.) so that captured/recorded data may be relayed to another computing device (e.g., an IoT device 404) for reporting.

In another example, if the trigger detected at operation 930 is receipt of a configuration message (e.g., obtained at operation 810 in process 800), the modem manager 520 may determine whether the configuration message indicates to add, delete, and/or update one or more of the MPs 577 and/or NAPs 575. In this example, the modem manager 520 may perform operations 815-835 of process 800, and identify/select any newly provisioned or updated MPs 577 in the secure storage 525.

Furthermore, the AP 578 may define criteria or conditions for delaying the identification/selection and provisioning of MPs 577 and/or NAPs 575, such as when a detected/identified trigger is based on a QoS level or data rate or bandwidth allocation. Such delay conditions/criteria may also include a detected RLF so that the computing platform 504 may attempt to re-transmit data after a predefined amount of time and for a predefined number of times, which may be instead or in addition to a number of retry attempts defined by the currently implemented wireless communication protocol. In these scenarios, the AP 578 may indicate that the computing platform 504 should store any captured data for reporting at a later time.

Some non-limiting examples are provided below.

Example 1 may include a platform for computing, the platform comprising: execution environment coupled with modem circuitry, the execution environment is to store a plurality of modem profiles corresponding to a plurality of communication protocols or networks, and the execution environment is to utilize an associated processing device to operate a modem manager to: detect a trigger to reconfigure the modem circuitry, select a modem profile of the plurality of modem profiles in response to the trigger, and reconfigure the modem circuitry in accordance with the selected modem profile; and the modem circuitry, on reconfiguration, communicates over a corresponding wireless network or in a corresponding network of the selected modem profile.

Example 2 may include the platform of example 1 and/or some other examples herein, wherein the execution environment is a secure execution environment (SEE), and wherein the SEE comprises a secure storage to store a plurality of network access profiles (NAPs), and each NAP of the plurality of NAPs is associated with a network operator and to be used for accessing an associated wireless network provided by the associated network operator.

Example 3 may include the platform of example 2 and/or some other examples herein, wherein each NAP comprises: a service access policy (SAP) to define one or more services that are accessible by the platform; one or more credentials to be used to authenticate the platform to attach to the associated wireless network, and authenticate the platform for access to the one or more services defined by the SAP; and a network access application (NAA) to be operated by the SEE, the NAA to authenticate the platform using the one or more credentials to access the associated wireless network and to access the one or more services.

Example 4 may include the platform of example 2 or 3 and/or some other examples herein, wherein the modem manager is to: receive, from a broker system via the modem circuitry, a configuration message comprising an access policy and a modem configuration, wherein the access policy is to indicate the trigger, and wherein the modem configuration is to instruct the modem manager to add one or more modem profiles to the stored plurality of modem profiles, delete one or more modem profiles from the stored plurality of modem profiles, update one or more modem profiles of the stored plurality of modem profiles, add one or more NAPs to the stored plurality of NAPs, delete one or more NAPs from the stored plurality of NAPs, or update one or more NAPs of the stored plurality of NAPs; verify the modem configuration and the access policy of the configuration message; apply the modem configuration to the modem profiles and NAPs in the secure storage.

Example 5 may include the platform of example 4 and/or some other examples herein, wherein the modem manager is to: reconfigure the modem circuitry with an updated version of a currently implemented modem profile when the modem configuration indicates to update the currently implemented modem profile; and operate an updated version of a NAP associated with the currently implemented modem profile when the modem configuration indicates to update the NAP associated with the currently implemented modem profile.

Example 6 may include the platform of example 4, wherein the modem manager is to: send, to the broker system via the modem circuitry, a request for the configuration message, wherein the request is to be sent on a periodic basis or in response to a predetermined event.

Example 7 may include the platform of example 4 and/or some other examples herein, wherein the access policy further indicates a NAP to be used when a corresponding modem profile is implemented by the modem circuitry, and wherein: to select the modem profile, the modem manager is to select a modem profile of the plurality of modem profiles associated with the NAP indicated by the access policy, and the NAP indicated by the access policy is to be operated within the SEE.

Example 8 may include the platform of example 2 and/or some other examples herein, wherein the secure storage of the SEE is to store an access policy, and the modem manager is to obtain, from a selection agent, an instruction to switch a currently implemented NAP to another NAP, and wherein: the trigger is receipt of the instruction, to select the modem profile, the modem manager is to select a modem profile of the plurality of modem profiles associated with the other NAP indicated by instruction, and the NAP indicated by the instruction is to be operated within the SEE.

Example 9 may include the platform of example 1, wherein the trigger is detection of a radio link failure (RLF), and the modem manager is to: obtain an indication of an RLF from the modem circuitry.

Example 10 may include the platform of example 1 and/or some other examples herein, wherein the execution environment is implemented by management engine (ME) circuitry coupled with the modem circuitry, and wherein the ME circuitry comprises: at least one computer-readable medium to store program code of the modem manager; and at least one processing device to execute the program code of the modem manager, and wherein the modem manager is to communicate with the modem circuitry over an out-of-band (OOB) channel.

Example 11 may include the platform of example 10 and/or some other examples herein, wherein the ME circuitry is a system-on-chip (SoC) embedded in a host architecture of the platform, embedded in the modem circuitry, or mounted separate from the host architecture and the modem circuitry.

Example 12 may include the platform of example 1 and/or some other examples herein, wherein the platform further comprises: a host architecture comprising one or more application processors and one or more computer-readable media, wherein the execution environment is implemented by the host architecture, and wherein the execution environment comprises: one or more secure enclaves, wherein the one or more secure enclaves are isolated regions of the one or more computer-readable media of the host architecture, wherein program code of the modem manager is stored in a modem manager enclave of the one or more secure enclaves, and wherein the one or more application processors of the host architecture are to execute the program code of the modem manager within the modem manager enclave, and wherein the modem manager is to communicate with the modem circuitry over an OOB channel and using a bridge application within the modem manager enclave.

Example 13 may include the platform of example 12 and/or some other examples herein, wherein the OOB channel is to terminate at the bridge application and a proxy application, and wherein the proxy application is implemented by the host architecture or ME circuitry.

Example 14 may include the platform of any one of examples 11-13 and/or some other examples herein, wherein the modem circuitry is implemented as a reconfigurable field-programmable gate array (FPGA), and wherein the modem circuitry is to operate: update logic to obtain the selected modem profile via the OOB channel and store the selected modem profile in a non-volatile computer-readable media (NVM) of the modem circuitry; and configuration logic to deactivate a currently activated modem profile, load the selected stored modem profile into one or more logic blocks of the FPGA, and activate the selected modem profile.

Example 15 may include the platform of example 14 and/or some other examples herein, wherein the platform is implemented in a laptop personal computer, “PC”, a tablet PC, a smartphone, a wearable computing device, an Internet of Things (IoT) device, or a machine-type communications (MTC) device.

Example 16 may include modem circuitry comprising: a plurality of logic blocks and a plurality of memory cells, the plurality of logic blocks comprising: update logic to obtain a modem profile over an out-of-band (OOB) channel, and store the modem profile in the one or more memory cells; and configuration logic to deactivate a currently activated modem profile, load the stored modem profile into unoccupied logic blocks of the plurality of logic blocks, and activate the loaded modem profile, and wherein activation of the loaded modem profile is to cause the modem circuitry to modulate for transmission over an air interface and demodulate signals received over the air interface in accordance with a wireless communications protocol.

Example 17 may include the modem circuitry of example 16 and/or some other examples herein, wherein the update logic is to obtain the modem profile from a modem manager via a proxy application, wherein the modem manager is implemented by management engine (ME) circuitry or implemented within a secure enclave operated by application circuitry.

Example 18 may include the modem circuitry of example 17 and/or some other examples herein, wherein receipt of the modem profile is based on a detected trigger.

Example 19 may include the modem circuitry of examples 16-18 and/or some other examples herein, wherein, on activation of the modem profile, the modem circuitry is to provide the modulate signals to a transceiver for communication over a wireless network corresponding to the wireless communication protocol, and receive signals for demodulation from the transceiver.

Example 20 may include the modem circuitry of examples 16-19 and/or some other examples herein, wherein the modem circuitry comprises a field-programmable device (FPD), a field-programmable gate array (FPGA), a programmable logic device (PLD), a complex PLD (CPLD), a high-capacity PLD (HCPLD), an application-specific integrated circuit (ASIC), a structured ASIC, or a programmable System on Chip.

Example 21 may include one or more computer-readable media having instructions that, when executed by one or more processors of a secure execution environment (SEE), cause a computer device to: detect a trigger to reconfigure modem circuitry of the computer device; select a modem profile of a plurality of modem profiles in response to the trigger; and reconfigure the modem circuitry in accordance with the selected modem profile, wherein the modem circuitry, on reconfiguration, is to communicate over a corresponding wireless network or according to corresponding protocol of the selected modem profile.

Example 22 may include the one or more computer-readable media of example 21 and/or some other examples herein, wherein the SEE comprises a secure storage to store a plurality of network access profiles (NAPs), and each NAP of the plurality of NAPs is associated with a network operator and to be used for accessing an associated wireless network provided by the associated network operator.

Example 23 may include the one or more computer-readable media of example 22 and/or some other examples herein, wherein each NAP comprises: a network access policy to define one or more services that are accessible by the platform; one or more credentials to be used to authenticate the platform to attach to the associated wireless network, and authenticate the platform for access to the one or more services defined by the network; and a network access application (NAA) to be operated by the one or more processors of the SEE, the NAA to authenticate the platform using the one or more credentials to access the associated wireless network and to access the one or more services.

Example 24 may include the one or more computer-readable media of example 22 or 23 and/or some other examples herein, wherein the computer device, in response to execution of the instructions, is to: receive, from a broker system via the modem circuitry, a configuration message comprising an access policy and a modem configuration, wherein the access policy is to indicate the trigger, and wherein the modem configuration is to instruct the modem manager to add one or more modem profiles to the stored plurality of modem profiles, delete one or more modem profiles from the stored plurality of modem profiles, update one or more modem profiles of the stored plurality of modem profiles, add one or more NAPs to the stored plurality of NAPs, delete one or more NAPs from the stored plurality of NAPs, or update one or more NAPs of the stored plurality of NAPs; verify the modem configuration and the access policy of the configuration message; apply the modem configuration to the modem profiles and NAPs in the secure storage.

Example 25 may include the one or more computer-readable media of example 24, and/or some other examples herein wherein the computer device, in response to execution of the instructions, is to: reconfigure the modem circuitry with an updated version of a currently implemented modem profile when the modem configuration indicates to update the currently implemented modem profile; and operate an updated version of a NAP associated with the currently implemented modem profile when the modem configuration indicates to update the NAP associated with the currently implemented modem profile.

Example 26 may include the one or more computer-readable media of example 24 and/or some other examples herein, wherein the computer device, in response to execution of the instructions, is to: send, to the broker system via the modem circuitry, a request for the configuration message, wherein the request is to be sent on a periodic basis or in response to a predetermined event.

Example 27 may include the one or more computer-readable media of example 24 and/or some other examples herein, wherein the access policy further indicates a NAP to be used when a corresponding modem profile is implemented by the modem circuitry, wherein, to select the modem profile, the computer device, in response to execution of the instructions, is to: select a modem profile of the plurality of modem profiles associated with the NAP indicated by the access policy, and operate the NAP indicated by the access policy within the SEE.

Example 28 may include the one or more computer-readable media of example 22 and/or some other examples herein, wherein the computer device, in response to execution of the instructions, is to: obtain, from a selection agent, an instruction to switch a currently implemented NAP to another NAP, wherein the trigger is receipt of the instruction; select a modem profile of the plurality of modem profiles associated with the other NAP indicated by instruction; and operate the NAP indicated by the instruction in the SEE.

Example 29 may include the one or more computer-readable media of example 21 and/or some other examples herein, wherein the trigger is detection of a radio link failure (RLF), and wherein the computer device, in response to execution of the instructions, is to: obtain an indication of an RLF from the modem circuitry.

Example 30 may include the one or more computer-readable media of example 21 and/or some other examples herein, wherein the SEE is implemented by management engine (ME) circuitry coupled with the modem circuitry, and wherein the ME circuitry comprises the one or more computer-readable media and the one or more processors, and wherein the modem manager is to communicate with the modem circuitry over an out-of-band (OOB) channel.

Example 31 may include the one or more computer-readable media of example 30 and/or some other examples herein, wherein the ME circuitry is a system-on-chip (SoC) embedded in a host architecture of the platform, embedded in the modem circuitry, or mounted separate from the host architecture and the modem circuitry.

Example 32 may include the one or more computer-readable media of example 21 and/or some other examples herein, wherein the SEE is implemented by a host architecture of the computer device, wherein the host architecture comprises the one or more processors and the one or more computer-readable media, and wherein the one or more computer-readable media comprises: one or more secure enclaves, wherein the one or more secure enclaves are isolated regions of the one or more computer-readable media of the host architecture, wherein the instructions are stored in a modem manager enclave of the one or more secure enclaves, and wherein the one or more processors of the host architecture are to execute the instructions within the modem manager enclave, and wherein the modem manager is to communicate with the modem circuitry over an OOB channel by execution of a bridge application within the modem manager enclave.

Example 33 may include the one or more computer-readable media of example 32 and/or some other examples herein, wherein the OOB channel is to terminate at the bridge application and a proxy application, and wherein the proxy application is implemented by the host architecture or ME circuitry.

Example 34 may include the one or more computer-readable media of any one of examples 31-33 and/or some other examples herein, wherein the modem circuitry comprises: a plurality of logic blocks and a plurality of memory cells, the plurality of logic blocks comprising: update logic to obtain a modem profile over an out-of-band (OOB) channel, and store the modem profile in the one or more memory cells; and configuration logic to deactivate a currently activated modem profile, load the stored modem profile into unoccupied logic blocks of the plurality of logic blocks, and activate the loaded modem profile, and wherein activation of the loaded modem profile is to cause the modem circuitry to modulate for transmission over an air interface and demodulate signals received over the air interface in accordance with a wireless communications protocol.

Example 35 may include the one or more computer-readable media of example 34 and/or some other examples herein, wherein, on activation of the modem profile, the modem circuitry is to provide the modulate signals to a transceiver for communication over a wireless network corresponding to the wireless communication protocol, and receive signals for demodulation from the transceiver.

Example 36 may include the one or more computer-readable media of examples 34-35 and/or some other examples herein, wherein the modem circuitry comprises a field-programmable device (FPD), a field-programmable gate array (FPGA), a programmable logic device (PLD), a complex PLD (CPLD), a high-capacity PLD (HCPLD), an application-specific integrated circuit (ASIC), a structured ASIC, or a programmable System on Chip.

Example 37 may include the one or more computer-readable media of example 36 and/or some other examples herein, wherein the one or more computer-readable media and the one or more processors are implemented in a laptop personal computer, “PC”, a tablet PC, a smartphone, a wearable computing device, an Internet of Things (IoT) device, or a machine-type communications (MTC) device.

Example 38 may include a method comprising: detecting, by a computer device, a trigger to reconfigure modem circuitry of the computer device; selecting, by the computer device, a modem profile of a plurality of modem profiles in response to the trigger; and reconfiguring, by the computer device, the modem circuitry in accordance with the selected modem profile, wherein the modem circuitry, on reconfiguration, is to communicate over a corresponding wireless network or according to corresponding protocol of the selected modem profile.

Example 39 may include the method of example 38 and/or some other examples herein, further comprising: storing, by the computer device in a secure storage of a secure execution environment, a plurality of network access profiles (NAPs), and each NAP of the plurality of NAPs is associated with a network operator and to be used for accessing an associated wireless network provided by the associated network operator.

Example 40 may include the method of example 39 and/or some other examples herein, wherein each NAP comprises: a network access policy to define one or more services that are accessible by the platform; one or more credentials to be used to authenticate the platform to attach to the associated wireless network, and authenticate the platform for access to the one or more services defined by the network; and a network access application (NAA) to be operated by the one or more processors of the SEE, the NAA to authenticate the platform using the one or more credentials to access the associated wireless network and to access the one or more services.

Example 41 may include the method of example 39 or 40 and/or some other examples herein, further comprising: receiving, by the computer device, from a broker system via the modem circuitry, a configuration message comprising an access policy and a modem configuration, wherein the access policy is to indicate the trigger, and, wherein the modem configuration indicates to add, delete or update one or more modem profiles or one or more NAPs; verifying, by the computer device, the modem configuration and the access policy of the configuration message; applying, by the computer device, the modem configuration to the modem profiles and NAPs in the secure storage.

Example 42 may include the method of example 41 and/or some other examples herein, further comprising: reconfiguring, by the computer device, the modem circuitry with an updated version of a currently implemented modem profile when the modem configuration indicates to update the currently implemented modem profile; and operating, by the computer device, an updated version of a NAP associated with the currently implemented modem profile when the modem configuration indicates to update the NAP associated with the currently implemented modem profile.

Example 43 may include the method of example 41 and/or some other examples herein, further comprising: sending, by the computer device to a broker system via the modem circuitry, a request for the configuration message, wherein the request is to be sent on a periodic basis or in response to a predetermined event.

Example 44 may include the method of example 41 and/or some other examples herein, wherein the access policy further indicates a NAP to be used when a corresponding modem profile is to be implemented by the modem circuitry, wherein the method comprises: selecting, by the computer device, a modem profile of the plurality of modem profiles associated with the NAP indicated by the access policy; and operating, by the computer device, the NAP indicated by the access policy within the SEE.

Example 45 may include the method of example 39 and/or some other examples herein, further comprising: obtaining, by the computer device from a selection agent, an instruction to switch a currently implemented NAP to another NAP, wherein the trigger is receipt of the instruction; selecting, by the computer device, a modem profile of the plurality of modem profiles associated with the other NAP indicated by instruction; and operating, by the computer device, the NAP indicated by the instruction in the SEE.

Example 46 may include the method of example 38 and/or some other examples herein, wherein the trigger is detection of a radio link failure (RLF), and wherein the method comprises: obtaining, by the computer device, an indication of an RLF from the modem circuitry.

Example 47 may include the method of example 38 and/or some other examples herein, wherein the computer device comprises management engine (ME) circuitry coupled with the modem circuitry, and wherein the ME circuitry comprises one or more computer-readable media and one or more processors, and wherein the ME circuitry is to communicate with the modem circuitry over an out-of-band (OOB) channel.

Example 48 may include the method of example 47 and/or some other examples herein, wherein the ME circuitry is a system-on-chip (SoC) embedded in a host architecture of the platform, embedded in the modem circuitry, or mounted separate from the host architecture and the modem circuitry.

Example 49 may include the method of example 38 and/or some other examples herein, wherein the computer device comprises application circuitry, wherein the application circuitry comprises one or more application processors and one or more computer-readable media, and wherein the one or more computer-readable media comprises: one or more secure enclaves, wherein the one or more secure enclaves are isolated regions of the one or more computer-readable media, wherein instructions for performing the method are stored in a modem manager enclave of the one or more secure enclaves, and wherein the one or more application processors are to execute the instructions within the modem manager enclave, and wherein applications within the modem manager enclave are to communicate with the modem circuitry over an OOB channel by execution of a bridge application within the modem manager enclave, and wherein the OOB channel is to terminate at the bridge application and a proxy application, and wherein the proxy application is implemented by the application circuitry or ME circuitry.

Example 50 may include the method of examples 38-49 and/or some other examples herein, wherein the modem circuitry comprises a field-programmable device (FPD), a field-programmable gate array (FPGA), a programmable logic device (PLD), a complex PLD (CPLD), a high-capacity PLD (HCPLD), an application-specific integrated circuit (ASIC), a structured ASIC, or a programmable System on Chip, and wherein the computer device is implemented in a laptop personal computer, “PC”, a tablet PC, a smartphone, a wearable computing device, an Internet of Things (IoT) device, or a machine-type communications (MTC) device.

Example 51 may include an apparatus comprising: communications means for communicating with one or more devices; means for detecting a trigger to reconfigure the communications means; means for selecting a communication profile of a plurality of communication profiles in response to the trigger; and means for reconfiguring the communications means in accordance with the selected communication profile, wherein the communications means, on reconfiguration, is for communicating over a corresponding wireless network or according to corresponding protocol of the selected communication profile.

Example 52 may include the apparatus of example 51 and/or some other examples herein, further comprising: means for storing, in a secure storage of a secure execution environment, a plurality of network access profiles (NAPs), and each NAP of the plurality of NAPs is associated with a network operator and to be used for accessing an associated wireless network provided by the associated network operator.

Example 53 may include the apparatus of example 52 and/or some other examples herein, wherein each NAP comprises: a network access policy to define one or more services that are accessible by the platform; one or more credentials to be used to authenticate the platform to attach to the associated wireless network, and authenticate the platform for access to the one or more services defined by the network; and a network access application (NAA) to be operated by the one or more processors of the SEE, the NAA to authenticate the platform using the one or more credentials to access the associated wireless network and to access the one or more services.

Example 54 may include the apparatus of example 52 or 53 and/or some other examples herein, further comprising: means for receiving, from a broker system via the communication means, a configuration message comprising an access policy and a modem configuration, wherein the access policy is to indicate the trigger, and, wherein the modem configuration indicates to add, delete or update one or more modem profiles or one or more NAPs; means for verifying the modem configuration and the access policy of the configuration message; means for applying the modem configuration to the communication profiles and NAPs in the secure storage.

Example 55 may include the apparatus of example 54 and/or some other examples herein, further comprising: means for reconfiguring the communication means with an updated version of a currently implemented communication profile when the modem configuration indicates to update the currently implemented communication profile; and means for operating an updated version of a NAP associated with the currently implemented communication profile when the modem configuration indicates to update the NAP associated with the currently implemented communication profile.

Example 56 may include the apparatus of example 54 and/or some other examples herein, further comprising: means for sending, to a broker system via the communication means, a request for the configuration message, wherein the request is to be sent on a periodic basis or in response to a predetermined event.

Example 57 may include the apparatus of example 54 and/or some other examples herein, wherein the access policy further indicates a NAP to be used when a corresponding communication profile is to be implemented by the communication means, the apparatus further comprising: means for selecting a communication profile of the plurality of communication profiles associated with the NAP indicated by the access policy; and means for operating the NAP indicated by the access policy within the SEE.

Example 58 may include the apparatus of example 52 and/or some other examples herein, further comprising: means for obtaining, from a selection agent, an instruction to switch a currently implemented NAP to another NAP, wherein the trigger is receipt of the instruction; means for selecting a communication profile of the plurality of communication profiles associated with the other NAP indicated by instruction; and means for operating the NAP indicated by the instruction in the SEE.

Example 59 may include the apparatus of example 51 and/or some other examples herein, wherein the trigger is detection of a radio link failure (RLF), and wherein the apparatus comprises: means for obtaining an indication of an RLF from the communication means.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, limited only by the claims.

1. A platform for computing, the platform comprising:
execution environment coupled with modem circuitry, the execution environment is to store a plurality of modem profiles corresponding to a plurality of communication protocols or networks, and the execution environment is to utilize an associated processing device to operate a modem manager to:
detect a trigger to reconfigure the modem circuitry,
select a modem profile of the plurality of modem profiles in response to the trigger, and
reconfigure the modem circuitry in accordance with the selected modem profile; and
the modem circuitry to communicate, on reconfiguration, over a corresponding wireless network or in a corresponding network of the selected modem profile.

2. The platform of claim 1, wherein the execution environment is a secure execution environment (SEE), and wherein the SEE comprises a secure storage to store a plurality of network access profiles (NAPs), and each NAP of the plurality of NAPs is associated with a network operator and to be used for accessing an associated wireless network provided by the associated network operator.

3. The platform of claim 2, wherein each NAP comprises:
a service access policy (SAP) to define one or more services that are accessible by the platform;
one or more credentials to be used to authenticate the platform to attach to the associated wireless network, and authenticate the platform for access to the one or more services defined by the SAP; and
a network access application (NAA) to be operated by the SEE, the NAA to authenticate the platform using the one or more credentials to access the associated wireless network and to access the one or more services.

4. The platform of claim 3, wherein the modem manager is to:
receive, from a broker system via the modem circuitry, a configuration message comprising an access policy and a modem configuration, wherein the access policy is to indicate the trigger, and wherein the modem configuration is to instruct the modem manager to add one or more modem profiles to the stored plurality of modem profiles, delete one or more modem profiles from the stored plurality of modem profiles, update one or more modem profiles of the stored plurality of modem profiles, add one or more NAPs to the stored plurality of NAPs, delete one or more NAPs from the stored plurality of NAPs, or update one or more NAPs of the stored plurality of NAPs;
verify the modem configuration and access policy of the configuration message;
apply the modem configuration to the modem profiles and NAPs in the secure storage.

5. The platform of claim 4, wherein the modem manager is to:
reconfigure the modem circuitry with an updated version of a currently implemented modem profile when the modem configuration indicates to update the currently implemented modem profile; and
operate an updated version of a NAP associated with the currently implemented modem profile when the modem configuration indicates to update the NAP associated with the currently implemented modem profile.

6. The platform of claim 4, wherein the modem manager is to:
send, to the broker system via the modem circuitry, a request for the configuration message, wherein the request is to be sent on a periodic basis or in response to a predetermined event.

7. The platform of claim 4, wherein the access policy further indicates a NAP to be used when a corresponding modem profile is implemented by the modem circuitry, and wherein:
to select the modem profile, the modem manager is to select a modem profile of the plurality of modem profiles associated with the NAP indicated by the access policy, and
the NAP indicated by the access policy is to be operated within the SEE.

8. The platform of claim 2, wherein the secure storage of the SEE is to store an access policy, and the modem manager is to obtain, from a selection agent, an instruction to switch a currently implemented NAP to another NAP, and wherein:
the trigger is receipt of the instruction,
to select the modem profile, the modem manager is to select a modem profile of the plurality of modem profiles associated with the other NAP indicated by instruction, and
the NAP indicated by the instruction is to be operated within the SEE.

9. The platform of claim 1, wherein the trigger is detection of a radio link failure (RLF), and the modem manager is to:
obtain an indication of an RLF from the modem circuitry.

10. The platform of claim 1, wherein the execution environment is implemented by management engine (ME) circuitry coupled with the modem circuitry, and wherein the ME circuitry comprises:
at least one computer-readable medium to store program code of the modem manager; and
at least one processing device to execute the program code of the modem manager, and
wherein the modem manager is to communicate with the modem circuitry over an out-of-band (OOB) channel.

11. The platform of claim 10, wherein the ME circuitry is a system-on-chip (SoC) embedded in a host architecture of the platform, embedded in the modem circuitry, or mounted separate from the host architecture and the modem circuitry.

12. The platform of claim 1, wherein the platform further comprises:
a host architecture comprising one or more application processors and one or more computer-readable media, wherein the execution environment is implemented by the host architecture, and wherein the execution environment comprises:
one or more secure enclaves, wherein the one or more secure enclaves are isolated regions of the one or more computer-readable media of the host architecture, wherein program code of the modem manager is stored in a modem manager enclave of the one or more secure enclaves, and wherein the one or more application processors of the host architecture are to execute the program code of the modem manager within the modem manager enclave, and
wherein the modem manager is to communicate with the modem circuitry over an OOB channel and using a bridge application within the modem manager enclave.

13. The platform of claim 12, wherein the OOB channel is to terminate at the bridge application and a proxy application, and wherein the proxy application is implemented by the host architecture or ME circuitry.

14. The platform of claim 1, wherein the modem circuitry is implemented as a reconfigurable field-programmable gate array (FPGA), and wherein the modem circuitry is to operate:
update logic to obtain the selected modem profile via an OOB channel and store the selected modem profile in a non-volatile computer-readable media (NVM) of the modem circuitry; and
configuration logic to deactivate a currently activated modem profile, load the selected stored modem profile into one or more logic blocks of the FPGA, and activate the selected modem profile.

15. The platform of claim 1, wherein the platform is implemented in a laptop personal computer, “PC”, a tablet PC, a smartphone, a wearable computing device, an Internet of Things (IoT) device, or a machine-type communications (MTC) device.

16. One or more computer-readable media having instructions that, when executed by one or more processors of a secure execution environment (SEE) of a computer device, cause the computer device to:
detect a trigger to reconfigure modem circuitry of the computer device;
select a modem profile of a plurality of modem profiles in response to the trigger; and
reconfigure the modem circuitry in accordance with the selected modem profile, wherein the modem circuitry, on reconfiguration, is to communicate over a corresponding wireless network or according to corresponding protocol of the selected modem profile.

17. The one or more computer-readable media of claim 16, wherein the SEE comprises a secure storage to store a plurality of network access profiles (NAPs), and each NAP of the plurality of NAPs is associated with a network operator and to be used for accessing an associated wireless network provided by the associated network operator.

18. The one or more computer-readable media of claim 17, wherein the computer device, in response to execution of the instructions, is to:
receive, from a broker system via the modem circuitry, a configuration message comprising an access policy and a modem configuration, wherein the access policy is to indicate the trigger, and wherein the modem configuration is to instruct the modem manager to add one or more modem profiles to the stored plurality of modem profiles, delete one or more modem profiles from the stored plurality of modem profiles, update one or more modem profiles of the stored plurality of modem profiles, add one or more NAPs to the stored plurality of NAPs, delete one or more NAPs from the stored plurality of NAPs, or update one or more NAPs of the stored plurality of NAPs;
verify the modem configuration and the access policy of the configuration message;
apply the modem configuration to the modem profiles and NAPs in the secure storage.

19. The one or more computer-readable media of claim 18, wherein the access policy further indicates a NAP to be used when a corresponding modem profile is to be implemented by the modem circuitry, wherein, to select the modem profile, the computer device, in response to execution of the instructions, is to:
select a modem profile of the plurality of modem profiles associated with the NAP indicated by the access policy, and
operate the NAP indicated by the access policy within the SEE.

20. The one or more computer-readable media of claim 17, wherein the computer device, in response to execution of the instructions, is to:
obtain, from a selection agent, an instruction to switch a currently implemented NAP to another NAP, wherein the trigger is receipt of the instruction;
select a modem profile of the plurality of modem profiles associated with the other NAP indicated by the instruction; and
operate the NAP indicated by the instruction in the SEE.

21. A method comprising:
detecting, by a computer device, a trigger to reconfigure modem circuitry of the computer device;
selecting, by the computer device, a modem profile of a plurality of modem profiles in response to the trigger; and
reconfiguring, by the computer device, the modem circuitry in accordance with the selected modem profile, wherein the modem circuitry, on reconfiguration, is to communicate over a corresponding wireless network or according to corresponding protocol of the selected modem profile.

22. The method of claim 21, further comprising:
storing, by the computer device in a secure storage of a secure execution environment, a plurality of network access profiles (NAPs), and each NAP of the plurality of NAPs is associated with a network operator and to be used for accessing an associated wireless network provided by the associated network operator.

23. The method of claim 22, further comprising:
receiving, by the computer device, from a broker system via the modem circuitry, a configuration message comprising an access policy and a modem configuration message, wherein the access policy is to indicate the trigger, and wherein the modem configuration indicates to add, delete or update one or more modem profiles or one or more NAPs;
verifying, by the computer device, the modem configuration and the access policy of the configuration message;
applying, by the computer device, the modem configuration to the modem profiles and NAPs in the secure storage.

24. The method of claim 23, further comprising:
reconfiguring, by the computer device, the modem circuitry with an updated version of a currently implemented modem profile when the modem configuration message indicates to update the currently implemented modem profile;
operating, by the computer device, an updated version of a NAP associated with the currently implemented modem profile when the modem configuration message indicates to update the NAP associated with the currently implemented modem profile;
selecting, by the computer device, a modem profile of the plurality of modem profiles associated with the NAP indicated by the access policy; and
operating, by the computer device, the NAP indicated by the access policy within the SEE.

25. The method of claim 22, further comprising:
obtaining, by the computer device from a selection agent, an instruction to switch a currently implemented NAP to another NAP, wherein the trigger is receipt of the instruction;
selecting, by the computer device, a modem profile of the plurality of modem profiles associated with the other NAP indicated by instruction; and
operating, by the computer device, the NAP indicated by the instruction in the SEE.
